(19) United States
(12) Patent Application Publication
(10) Pub. No.: US 2026/0057307 A1
(43) Pub. Date: Feb. 26, 2026

(54) Model Processing Method, and Communication Device

(71) Applicant: VIVO MOBILE COMMUNICATIONS CO., LTD., Dongguan (CN)

(72) Inventors: Hui Jin, Dongguan (CN); Weiwei Chong, Dongguan (CN); Xiaobo Wu, Dongguan (CN)

(21) Appl. No.: 19/377,257

(22) Filed: Nov. 3, 2025

Related U.S. Application Data
(63) Continuation of application No. PCT/CN2024/090734, filed on Apr. 30, 2024.

(30) Foreign Application Priority Data
May 6, 2023 (CN) 202310506302.5

(51) Int. Cl. G06N 20/00

(52) U.S. Cl. CPC G06N 20/00

(57) ABSTRACT

A model processing method includes sending, by a first device, a first message to at least one second device. The first message includes a first model file corresponding to a first model, and receiving, by the first device, a second message returned by the second device. The second message includes at least one of the following; processing result information used for indicating a result obtained by processing the first model file, or a second model file, where the second model file is obtained by converting the first model file.

### CROSS-REFERENCE TO RELATED APPLICATIONS

This application is a Bypass Continuation application of International Patent Application No. PCT/CN2024/090734 filed Apr. 30, 2024, and claims priority to Chinese Patent Application No. 202310506302.5 filed May 6, 2023, the disclosures of which are hereby incorporated by reference in their entireties.

### BACKGROUND OF THE INVENTION

### Field of the Invention

This application pertains to the field of communication technologies, and in particular, relates to a model processing method, and a communication device.

### Description of Related Art

In the communication network, the artificial intelligence (AI) method is introduced to improve the network communication performance. A network-side device or a terminal can first conduct AI or machine learning (ML) model training based on training data to obtain a corresponding model suitable for an AI task; and then sends a trained AI/ML model to other terminal devices, so that other terminal devices can perform inference on input inference data for an AI task based on the AI/ML model, so as to obtain inference result data corresponding to a AI task. Using the terminal being user equipment (UE) as an example, the UE predicts a signal strength based on the AI/ML model and sends a predicted signal strength to a base station device, enabling the base station device to select a more accurate handover occasion.

### SUMMARY OF THE INVENTION

According to a first aspect, a model processing method is provided, where the method is executed by a first device, and the method includes:
sending, by the first device, a first message to at least one second device, where the first message includes a first model file corresponding to a first model; and
receiving, by the first device, a second message returned by the second device; where
the second message includes at least one of the following:
processing result information used for indicating a result obtained by processing the first model file; or
a second model file, where the second model file is obtained by converting the first model file.

According to a second aspect, a model processing method is provided, where the method is executed by a second device, and the method includes:
receiving, by the second device, a first message sent by a first device, where the first message includes a first model file corresponding to a first model; and
returning, by the second device, a second message to the first device; where
the second message includes at least one of the following:
processing result information used for indicating a result obtained by processing the first model file; or
a second model file, where the second model file is obtained by converting the first model file.

According to a third aspect, a model execution method is provided, where the method is executed by a first terminal, and the method includes:
obtaining, by the first terminal, a fifth message, where the fifth message includes a first model file corresponding to a first model or a second model file, and the second model file is obtained by converting the first model file; and
executing, by the first terminal, the first model file or the second model file.

According to a fourth aspect, a model registration method is provided, where the method is executed by a third device, and the method includes:
sending, by the third device, a third message to a first device, where the third message includes a first model file corresponding to a first model, and the third message is used for registering the first model; and
receiving, by the third device, a fourth message returned by the first device; where
the fourth message includes at least one of the following:
processing result information used for indicating a result obtained by processing the first model file; or
a second model file, where the second model file is obtained by converting the first model file.

According to a fifth aspect, a model processing apparatus is provided, including:
a first sending module, configured to send a first message to at least one second device, where the first message includes a first model file corresponding to a first model; and
a first receiving module, configured to receive a second message returned by the second device; where
the second message includes at least one of the following:
processing result information used for indicating a result obtained by processing the first model file; or
a second model file, where the second model file is obtained by converting the first model file.

According to a sixth aspect, a model processing apparatus is provided, including:
a second receiving module, configured to receive a first message sent by a first device, where the first message includes a first model file corresponding to a first model; and
a returning module, configured to return a second message to the first device; where
the second message includes at least one of the following:
processing result information used for indicating a result obtained by processing the first model file; or
a second model file, where the second model file is obtained by converting the first model file.

According to a seventh aspect, a model execution apparatus is provided, including:
an obtaining module, configured to obtain a fifth message, where the fifth message includes a first model file corresponding to a first model or a second model file, and the second model file is obtained by converting the first model file; and an execution module, configured to execute the first model file or the second model file.

According to an eighth aspect, a model registration apparatus is provided, including:
a second sending module, configured to send a third message to a first device, where the third message includes a first model file corresponding to a first model, and the third message is used for registering the first model; and
a third receiving module, configured to receive a fourth message returned by the first device; where
the fourth message includes at least one of the following:
processing result information used for indicating a result obtained by processing the first model file; or
a second model file, where the second model file is obtained by converting the first model file.

According to a ninth aspect, a first terminal is provided, where the first terminal includes a processor and a memory, where a program or instructions executable on the processor are stored in the memory. When the program or the instructions are executed by the processor, the steps of the method according to the third aspect are implemented.

According to a tenth aspect, a first terminal is provided, including a processor and a communication interface, where the communication interface is configured to obtain a fifth message, where the fifth message includes a first model file corresponding to a first model or a second model file, and the second model file is obtained by converting the first model file; and the processor is configured to execute the first model file or the second model file.

According to an eleventh aspect, a communication device is provided, including a processor and a memory, where the memory stores a program or instructions, and when the program or the instructions are executed by the processor, the steps of the model processing method according to the first aspect are implemented, or the steps of the model processing method according to the second aspect are implemented, or the steps of the model execution method according to the third aspect are implemented, or the steps of the model registration method according to the fourth aspect are implemented.

According to a twelfth aspect, a non-transitory readable storage medium is provided, where a program or instructions are stored in the non-transitory readable storage medium; and when the program or the instructions are executed by a processor, the steps of the model processing method according to the first aspect are implemented, or the steps of the model processing method according to the second aspect are implemented, or the steps of the model execution method according to the third aspect are implemented, or the steps of the model registration method according to the fourth aspect are implemented.

According to a thirteenth aspect, a wireless communication system is provided, including a first device, a second device, a first terminal, and a third device, where the first device can be configured to perform the steps of the model processing method according to the first aspect, the second device can be configured to perform the steps of the model processing method according to the second aspect, the first terminal can be configured to perform the steps of the model execution method according to the third aspect, and the third device can be configured to perform the steps of the model registration method according to the fourth aspect.

According to a fourteenth aspect, a chip is provided, where the chip includes a processor and a communication interface, the communication interface is coupled to the processor, and the processor is configured to run a program or instructions to implement the model processing method according to the first aspect, or the model processing method according to the second aspect, or the model execution method according to the third aspect, or the model registration method according to the fourth aspect.

According to a fifteenth aspect, a computer program/program product is provided, where the computer program/program product is stored in a non-transitory storage medium, and the program/program product is executed by at least one processor to implement the steps of the model processing method according to the first aspect, or the steps of the model processing method according to the second aspect, or the steps of the model execution method according to the third aspect, or the steps of the model registration method according to the fourth aspect.

### BRIEF DESCRIPTION OF THE DRAWINGS

FIG. 1 is a block diagram of a wireless communication system to which embodiments of this application are applicable;

FIG. 2 is a first schematic flowchart of a model processing method according to an embodiment of this application;

FIG. 3 is a second schematic flowchart of a model processing method according to an embodiment of this application;

FIG. 4 is a schematic flowchart of a model execution method according to an embodiment of this application;

FIG. 5 is a schematic flowchart of a model registration method according to an embodiment of this application;

FIG. 6 is a first schematic diagram of signaling interaction of a model processing, registration and execution method according to an embodiment of this application;

FIG. 7 is a second schematic diagram of signaling interaction of a model processing, registration and execution method according to an embodiment of this application;

FIG. 8 is a third schematic diagram of signaling interaction of a model processing, registration and execution method according to an embodiment of this application;

FIG. 9 is a fourth schematic diagram of signaling interaction of a model processing, registration and execution method according to an embodiment of this application;

FIG. 10 is a fifth schematic diagram of signaling interaction of a model processing, registration and execution method according to an embodiment of this application;

FIG. 11 is a sixth schematic diagram of signaling interaction of a model processing, registration and execution method according to an embodiment of this application;

FIG. 12 is a seventh schematic diagram of signaling interaction of a model processing, registration and execution method according to an embodiment of this application;

FIG. 13 is a first schematic structural diagram of a model processing apparatus according to an embodiment of this application;

FIG. 14 is a second schematic structural diagram of a model processing apparatus according to an embodiment of this application;

FIG. 15 is a schematic structural diagram of a model execution apparatus according to an embodiment of this application;

FIG. 16 is a schematic structural diagram of a model registration apparatus according to an embodiment of this application;

FIG. 17 is a schematic structural diagram of a communication device according to an embodiment of this application;

FIG. 18 is a schematic structural diagram of a first terminal according to an embodiment of this application;

FIG. 19 is a first schematic structural diagram of a third device according to an embodiment of this application; and

FIG. 20 is a second schematic structural diagram of a third device according to an embodiment of this application.

### DESCRIPTION OF THE INVENTION

The following clearly describes the technical solutions in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application fall within the protection scope of this application.

The terms “first”, “second”, and the like in this application are used to distinguish between similar objects instead of describing a specific order or sequence. It should be understood that terms used in this way are interchangeable in appropriate circumstances so that the embodiments of this application can be implemented in other orders than the order illustrated or described herein. In addition, “first” and “second” are usually used to distinguish objects of a same type, and do not restrict a quantity of objects. For example, there may be one or a plurality of first objects. In addition, the “or” in this application means at least one of the associated objects. For example, “A or B” covers three schemes, namely, scheme 1: including A not B; scheme 2: including B not A; and scheme 3: including both A and B. The character “/” generally represents an “or” relationship between the associated objects.

The term “indication” in this application may be either a direct indication (or an explicit indication) or an indirect indication (or an implicit indication). The direct indication may be understood as: a sender explicitly notifies, in a sent indication, a receiver of content such as information, an operation that needs to be performed, or a request result; and the indirect indication may be understood as: the receiver determines corresponding information or performs determining according to the indication sent by the sender, and determines, according to a determining result, an operation that needs to be performed or a request result.

It should be noted that technologies described in the embodiments of this application are not limited to a long term evolution (LTE) or LTE-Advanced (LTE-A) system, and may also be applied to other wireless communication systems, for example, code division multiple access (CDMA), time division multiple access (TDMA), frequency division multiple access (FDMA), orthogonal frequency division multiple access (OFDMA), single-carrier frequency-division multiple access (SC-FDMA), or other systems. The terms “system” and “network” in the embodiments of this application are often used interchangeably, and the technology described herein may be used in the above-mentioned systems and radio technologies as well as other systems and radio technologies. In the following descriptions, a new radio (NR) system is described for an illustration purpose, and NR terms are used in most of the following descriptions, although these technologies may also be applied to other systems than an NR system, for example, the 6th generation (6G) communication system.

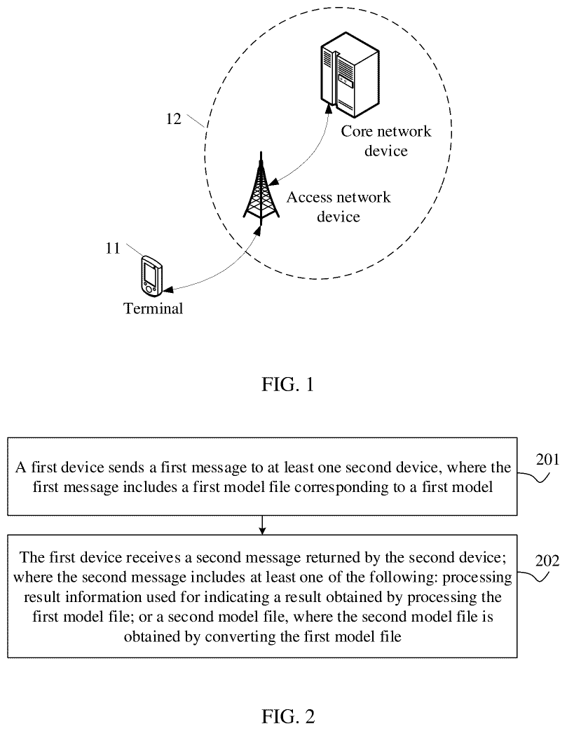

FIG. 1 is a block diagram of a wireless communication system to which embodiments of this application are applicable. The wireless communication system includes a terminal 11 and a network-side device 12. The terminal 11 may be a terminal-side device such as a mobile phone, a tablet computer (Tablet Personal Computer), a laptop computer, a notebook computer, a personal digital assistant (PDA), a palmtop computer, a netbook, an ultra-mobile personal computer (UMPC), a mobile Internet device (MID), an augmented reality (AR) or virtual reality (VR) device, a robot, a wearable device, a flight vehicle, vehicle user equipment (VUE), ship equipment, pedestrian user equipment (PUE), a smart home device (a home device with wireless communication function, such as a refrigerator, a television, a washing machine, or a furniture), a game console, a personal computer (PC), a teller machine, a self-service machine, or the like. The wearable device includes: a smart watch, a smart band, smart earphones, smart glasses, smart jewelry (smart bracelet, smart wristband, smart ring, smart necklace, smart anklet, smart ankle bracelet, or the like), smart wristband, smart clothing, and the like. The vehicle user equipment may alternatively be referred to as a vehicle-mounted terminal, a vehicle-mounted controller, a vehicle-mounted module, a vehicle-mounted component, a vehicle-mounted chip, or vehicle-mounted unit. In addition to the terminal device, the terminal may alternatively be a chip in the terminal, such as a modem chip or a system on chip (SoC). It should be noted that the terminal 11 is not limited to any type in the embodiments of this application. The network-side device 12 may include an access network device or a core network device, where the access network device may also be referred to as a radio access network (RAN), a radio access network function, or a radio access network unit. The access network device may include a base station, a wireless local area network (WLAN) access point (AS), a wireless fidelity (WiFi) node, or the like. The base station may be referred to as a Node B (NB), an evolved Node B (eNB), a next generation Node B (gNB), a new radio Node B (NR Node B), an access point, a relay base station (RBS), a serving base station (SBS), a base transceiver station (BTS), a radio base station, a radio transceiver, a basic service set (BSS), an extended service set (ESS), a home Node B (HNB), a home evolved Node B, a transmission and reception point (Transmission Reception Point, TRP), or another appropriate term in the art. Provided that a same technical effect is achieved, the base station is not limited to a technical term. It should be noted that in the embodiments of this application, the base station in the NR system is merely used as an example, and a type of the base station is not limited.

The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF), an edge application server discovery function (EASDF), a unified data management (UDM), a unified data repository (UDR), a home subscriber server (HSS), a centralized network configuration (CNC), a network repository function (NRF), a network exposure function (NEF), a local NEF (or L-NEF), a binding support function (BSF), an application function (AF), or the like. It should be noted that in the embodiments of this application, only the core network device in the NR system is introduced as an example, and the type of the core network device is not limited.

The following describes the model processing method, the model execution method, and the model registration method provided in the embodiments of this application through some embodiments and application scenarios thereof with reference to the accompanying drawings.

First, the model registration method provided by the embodiments of this application is described. Generally, it is not possible to uniformly manage models generated or trained by different network-side devices or terminals, leading to inconsistencies in understanding of models between terminals and the network-side devices when using the models by the terminal. Consequently, the terminals cannot properly use the models. Generally, different UE vendors employ their own optimization methods for communication models. When a network-side device or UE sends a trained AI/ML model to other UEs, there may be a probability that other UEs cannot properly use the model. Therefore, how to prevent terminals from being unable to properly use such models is a technical problem that urgently needs to be resolved. To address this technical issue, the embodiments of this application provide a model registration method, including steps 1 to 3:

Step 1: A third device sends a third message to a first device, where the third message includes a first model file corresponding to a first model, and the third message is used for registering (Register) the first model.

Optionally, the third message being used for registering the first model can alternatively be understood as the third message being used to publish the first model. The same applies hereinafter and will not be repeated.

Optionally, the first device is used to store models, and the first device may include at least one of the following: (a) a model store, used for storing models; (b) a NEF; (c) an analytic data repository function (ADRF); or (d) an NRF.

Optionally, the first model file includes: structural information of the first model or parameter information of the first model. The parameter information includes: a parameter type list or a parameter value.

Optionally, the first model file can be understood as the model file itself; or storage address information of the model file, such as information for indicating a download address of the first model file, a uniform resource locator (URL) position, or information about the storage device.

The third device is used for generating or training a model, and the third device may include at least one of the following: (a) a core network device of a 3rd generation partnership project (3GPP) network; (b) a RAN in the 3GPP network; (c) a target server device, such as a third-party server (3rd Server); or (d) a second terminal, where the second terminal is a terminal capable of generating a model or training a model; and the second terminal may be the same as the first terminal or may be different from the first terminal. Optionally, the core network device includes, but is not limited to, the foregoing types of the network-side device 12, which is not limited in this application.

Optionally, the third message may further include first information, where the first information may include at least one of the following:
(1) information for indicating a version number of the first model;
(2) information for indicating at least one parameter corresponding to the first model;
(3) information for indicating a use condition or a use scenario of the first model;
(4) information for indicating at least one function supported by the first model;
(5) information for indicating a generating device or a training device of the first model; or
(6) information for indicating a using device of the first model.

Optionally, the information about the version number of the first model can also be understood as the version number or version identity (ID) of the first model. The same applies hereinafter and will not be repeated.

Optionally, the information about the at least one parameter corresponding to the first model can also be understood as a parameter list. The information about the at least one parameter corresponding to the first model is used to indicate input and output parameters of the model. The same applies hereinafter and will not be repeated.

Optionally, the information for indicating the use condition or use scenario of the first model can alternatively be understood as an activation condition. Such information is used to indicate environmental parameters used for activation of the first model. The environmental parameters may include: a time parameter, such as activation only at a specific time point or time period; a location parameter, such as activation in a specific tracking area (TA), in a cell, at a site, or at a latitude and longitude position; a channel environment parameter, such as an antenna port, a carrier frequency, a bandwidth, separate channel signaling (SCS); and channel characteristics, such as a signal to noise ratio (SNR), a line of sight (LOS), or a non-line of sight (Non LOS, NLOS). The same applies hereinafter and will not be repeated.

Optionally, the information about the function supported by the first model is used to specify an inference purpose for which the first model is used for a specific task type (which is identified by function type or analytic ID). For example, the inference purpose may include trajectory prediction, channel state information (CSI) compression/decompression, AI positioning, beam prediction, or the like.

Optionally, the information about the generating device or training device of the first model can also be understood as a producer identifier, such as an ID, a fully qualified domain name (FQDN), an IP address, or the like. The producer vendor may include a vendor name or vendor ID.

Optionally, the information about the using device of the first model can also be understood as a consumer identifier, such as ID, FQDN, IP address, type allocation code (TAC), or a consumer vendor, and may include a vendor name or vendor ID. This information is used to restrict consumer of the model to a specific range.

Step 2: The first device receives the third message sent by the third device; and the first device assigns a first identifier to the first model.

Optionally, the first identifier may be a model identifier (model ID).

Step 3: The first device sends a fourth message to the third device.

The fourth message may include at least one of the following:
processing result information used for indicating a result obtained by processing the first model file; or
a second model file, where the second model file is obtained by converting the first model file.

Optionally, the processing result information can be used to indicate a result obtained by processing the first model file by the second device. The second model file is obtained by converting the first model file by the second device.

Optionally, the fourth message may further include at least one of the following: a first identifier; the first model file; first information; or first indication information for indicating information about a manufacturer corresponding to the second device.

In the model registration method provided in the embodiments of this application, after receiving the third message for registering the first model, the first device assigns a globally unique first identifier to the first model, so as to register the first model to the first device. This achieves unified management of models generated by different model training parties, ensuring that the network side and terminals have a consistent understanding on the first model.

FIG. 2 is a first schematic flowchart of a model processing method according to an embodiment of this application. As shown in FIG. 2, the method includes steps 201 and 202.

Step 201: A first device sends a first message to at least one second device, where the first message includes a first model file corresponding to a first model.

It should be noted that the embodiments of this application can be applied to scenarios involving the management and adaptation of models generated or trained by different devices. Due to different optimization methods employed by various UE vendors for models in general technologies, when different model training parties send their trained models to the first terminal, some models may not be executed correctly on the first terminal, leading to model incompatibility issues.

To resolve this problem, in this embodiment of the application, the first device sends the first message to at least one second device, requesting each second device to process the first model separately, including at least one of the following:
(a) testing parameters usable by the model to check whether the first model can be used properly on the second device or to check whether the first model can be used properly on a terminal device associated with the second device; or
(b) performing security authentication on the model.

Optionally, the second device can alternatively convert the first model file, for example, performing mode conversion or format conversion. Mode conversion or format conversion refers to transforming the first model from a model mode not supported by the terminal vendor or terminal device associated with the second device into a model mode supported by that terminal vendor. The first model may include an AI model, an ML model, or the like. The model mode of the first model, for example, refers to an encoding format of the first model file, such as an open neural network exchange (ONNX) model format.

Optionally, processing the first model by the second device can also be understood as checking (check), testing (test), validating (validate), checking out (checkout), or verifying (verify) the first model. The same applies hereinafter and will not be repeated.

Optionally, the model mode can also be understood as the model format. The same applies hereinafter and will not be repeated.

Optionally, the first device includes at least one of the following: (a) a model store; (b) a NEF; (c) an ADRF; or (d) an NRF. Optionally, the second device includes a UE vendor server.

It should be noted that the first message includes the first model file corresponding to the first model. Since different UE vendors have their own optimization methods for models, after the second device receives the first message including the first model file from the first device, the second device verifies the model mode of the first model based on the first message. Correspondingly, the second device may support the model mode of the first model file, or may not support the model mode of the first model file.

Optionally, verifying the model mode of the first model can also be understood as checking, testing, confirming or checking out the first model. The same applies hereinafter and will not be repeated.

In a case that the second device supports the model mode of the first model file, the second device needs to process the first model file, such as by checking, testing, confirming, checking out, or verifying, to determine whether the first model file can be used properly on the second device.

Optionally, the first model file being used properly on the second device can also be understood as the first model file being used properly on the terminal device associated with the second device. The same applies hereinafter and will not be repeated.

In a case that the second device does not support the model mode of the first model file, the second device needs to convert the first model file to generate a second model file of the first model, where a model mode of the second model file is a model mode supported by the second device. After generating the second model file, the second device needs to check, test, confirm, check out, or verify the second model file to ensure that the second model file can be used properly on the second device.

Optionally, the second model file being used properly on the second device can also be understood as the second model file being used properly on the terminal device associated with the second device. The same applies hereinafter and will not be repeated.

Optionally, “being used properly” in this application can also be understood as normal operation, correct operation, or operation without bugs (Bug). The same applies hereinafter and will not be repeated.

Step 202: The first device receives a second message returned by the second device; where the second message includes at least one of the following: processing result information used for indicating a result obtained by processing the first model file; or a second model file, where the second model file is obtained by converting the first model file.

Optionally, the second model file can be correctly executed on the first terminal associated with the second device. Optionally, the first terminal includes, but is not limited to, the types of the terminal 11 listed above.

In this embodiment of this application, the second message is, for example, a model check response message or a model conversion response message.

Optionally, the processing result information may indicate a result of checking, testing, confirming, checking out, or verifying the first model file by the second device. Using the processing result information indicating a test result as an example, and the test result includes test success or test failure.

In a case that the test result includes test success, it means that the first model file or the second model file can be used properly on the second device. In a case that the test result includes test failure, it means that the first model file or the second model cannot be used properly on the second device, that is, the second device does not support the first model.

For example, if the second device tests and finds that the first model file can be used properly on the second device, the second device returns processing result information to the first device, indicating that the test result is test success. For another example, if the second device tests and finds that the first model file cannot be used properly on the second device, the second device converts the first model file to generate a second model file. Then, the second device tests the second model file. If the second model file can be used properly on the second device, the second device returns processing result information and the second model file to the first device, indicating that the test result for the second model file is test success.

In a case that the test result indicated by the processing result information is test failure, the second device only returns the processing result information to the first device, indicating that the test result is test failure, meaning the second device does not support the first model.

Optionally, the second message may further include first indication information for indicating a manufacturer associated with the second device. The first indication information may be, for example, a vendor ID.

Correspondingly, when the first device receives second messages from a plurality of second devices, the first device can determine, based on the first indication information, which second device the second message comes from.

In this embodiment of this application, the first device sends a first message to at least one second device, where the first message includes a first model file corresponding to a first model; and then the first device receives a second message returned by the second device, where the second message includes at least one of processing result information or a second model file, the processing result information is used for indicating a result obtained by processing the first model file, and the second model file is obtained by converting the first model file. Based on the processing result information, the first device can learn whether the first model file can be correctly executed in the second device and a terminal associated with the second device. Based on that the second message includes the second model file, the first device can determine that the second model file can be correctly executed in the second device and the terminal associated with the second device. Therefore, based on the received processing result information or the second model file, the first device can determine whether the first model can be correctly executed in the terminal associated with the second device, so as to avoid a problem that the terminal cannot properly use the model.

Optionally, before sending the first message to at least one second device, the first device needs to receive a registration request from a model training party to register the model trained by the model training party as the first model. This can be implemented through the following step:

The first device receives a third message sent by a third device, where the third message includes the first model file, and the third message is used for registering the first model.

In this embodiment of this application, the third device is used for training the model to generate a trained first model. After generating the first model, the third device sends the third message to the first device. Correspondingly, the first device needs to receive the third message sent by the third device, where the third message is used to register the first model to the first device, enabling the first device to store the first model.

Optionally, the third device includes at least one of the following:
(a) a core network device;
(b) a RAN;
(c) a target server device, such as a 3rd server; or
(d) a second terminal, where the second terminal may be the same as the first terminal, or may be different from the first terminal. That is, other terminals can train the model and then register the trained first model to the first device, or the first terminal can train the model and then register the trained first model to the first device.

Optionally, before the first device sends the first message to at least one second device, the first device assigns a first identifier to the first model.

That is, the first device needs to assign a globally unique identifier, such as a first identifier or model ID, to the first model associated with the first model file. By assigning the first identifier to the first model, the first device implements unified management of models generated by different model training parties, ensuring that the network side and the terminal have a consistent understanding on the first model.

For example, in a scenario where the network side indicates the first terminal to execute the first model, the first device assigns a globally unique first identifier to the first model, allowing the network side to indicate the first terminal based on the first identifier to execute the first model. In this way, the network side and the first terminal have a consistent understanding on the first model, implementing unified management of models generated by different model training parties.

Optionally, the first message further includes the first identifier. That is, the first message sent by the first device to the second device also includes the first identifier of the first model, so that the first device and the second device have consistent understanding on the first model.

Optionally, the first message further includes first information, where the first information includes at least one of the following:
(a) Information for indicating a version number of the first model, such as version ID or version number corresponding to the first model.
(b) Information for indicating at least one parameter corresponding to the first model, for example, a parameter list corresponding to the first model.
(c) Information for indicating a use condition or a use scenario of the first model, such as a condition under which the first model can be used, namely a validity condition or an applicable condition of the first model, including a time condition (for example, activation only at a specific time point or period); a location condition, for example, activation in a specific TA, in a cell, at a site, or at a latitude and longitude position; a channel condition, for example, an antenna port, a carrier frequency, a bandwidth, an SCS, or channel characteristics; a scenario condition; a speed condition; or a range of accessible cells or a cell ID list.
(d) Information indicating at least one function (Function type or analytic ID) supported by the first model, for example, a function supported by the first model, for example, predicting a cell signal strength.
(e) Information for indicating a generating device or a training device of the first model, which may be, for example, a producer of the first model.
(f) Information for indicating a using device of the first model, which may be, for example, a consumer of the first model.

In the foregoing implementation, the second device can test the first information included in the first message to ensure that the first information can be correctly executed on the second device, thereby ensuring that the first information can be correctly executed on the first terminal associated with the second device, avoiding incompatibility issues when the first terminal uses the first model.

Optionally, after receiving the second message returned by the second device, the first device needs to send a registration result or publish result to the third device, such as a model publish ack message, indicating that the first model has been registered or published in the first device. This can be implemented through the following step:

The first device sends a fourth message to the third device; where

the fourth message includes at least one of the following:
(a) the processing result information; or
(b) the second model file that is obtained by converting the first model file.

Optionally, the fourth message further includes at least one of the following:
(a) a first identifier;
(b) the first model file;
(c) first information; or
(d) first indication information for indicating information about a manufacturer corresponding to the second device, which may be, for example, a vendor ID.

Optionally, after sending the registration or publish result to the third device, the first device needs to send to the first terminal the information that is associated with the first model and that has been successfully tested by the second device, so as to ensure that the first model can be correctly executed on the first terminal. This can be implemented through the following step:

The first device sends a fifth message to the first terminal, where the fifth message includes the first model file or the second model file.

In a case that the fifth message includes the first model file, it indicates that the first device directly sends the first model file, which can be correctly executed on the second device, to the first terminal. If the fifth message includes the second model file, it indicates that the first model file cannot be correctly executed on the second device, and after the second device converts the first model file, the first device sends the second model file, which can be correctly executed on the second device, to the first terminal.

Optionally, the fifth message further includes at least one of the following: a first identifier; or first information, where the first information includes at least one of the following:
(a) information for indicating a version number of the first model;
(b) information for indicating at least one parameter corresponding to the first model;
(c) information for indicating a use condition or a use scenario of the first model;
(d) information for indicating at least one function supported by the first model;
(e) information for indicating a generating device or a training device of the first model; or
(f) information for indicating a using device of the first model.

In the foregoing implementation, the first device sends the first identifier to the first terminal, so that when the network side indicates the first terminal to execute the first model, the first terminal and the network side have a consistent understanding. Since the first information is information that has been successfully tested by the second device associated with the first terminal, sending the first information to the first terminal by the first device ensures that the first terminal can correctly execute the first information.

Optionally, a manner of sending the fifth message to the first terminal by the first device includes at least one of the following:

Manner 1: the first device sends the fifth message to the first terminal in a case that the first terminal has registered with the first device.

For example, the first terminal first registers with the model store, and then the model store can directly send the fifth message to the first terminal.

Manner 2: the first device sends a sixth message to the first terminal in a case that a first request is received from the first terminal, where the first request is used to query whether there is an undownloaded or updated model file, and the sixth message is used for indicating that there is an undownloaded or updated model file in the first device; and the first device sends the fifth message to the first terminal in a case that a second request is received from the first terminal, where the second request is used for obtaining the fifth message.

Optionally, the first request includes second indication information for indicating the manufacturer corresponding to the first terminal, such as a vendor ID or information of the terminal model. The second indication information is carried in an international mobile station equipment identity (IMEI) of the first terminal.

For example, the first terminal periodically requests the model store to check where there is an undownloaded or updated model file, and if there is an undownloaded or updated model file in the model store, notifies the first terminal; and then the first terminal retrieves the model file from the model store based on the notification.

Manner 3: the first device sends the fifth message to the first terminal in a case that a seventh message is received from the first terminal, where the seventh message includes at least one of the following: a first identifier; information for indicating a version number of the first model; or second indication information for indicating information about a manufacturer or terminal model corresponding to the first terminal.

For example, in a scenario where the network side indicates the first terminal to execute the first model, the network side may first send a model identifier list (model ID list) it supports to the first terminal, where the model ID list includes the first identifier. The first terminal compares its supported model ID list with a model ID list supported by the network side. If the first terminal determines that the first terminal lacks the first identifier, the first terminal sends a seventh message to the model store, requesting the model store to send the fifth message to the first terminal.

Optionally, the first terminal determining that it lacks the first identifier can also be understood as the first terminal determining that the first terminal has not stored the first identifier or has not stored the first model corresponding to the first identifier.

The seventh message includes at least one of the following: a first identifier; information for indicating a version number of the first model, such as a version ID; or second indication information for indicating the manufacturer corresponding to the first terminal, such as a vendor ID or information about the terminal model, where the second indication information is carried in the IMEI of the first terminal.

Optionally, the seventh message may further carry model capability information supported by the first terminal, and the model store may send the fifth message to the first terminal based on the model capability information supported by the first terminal.

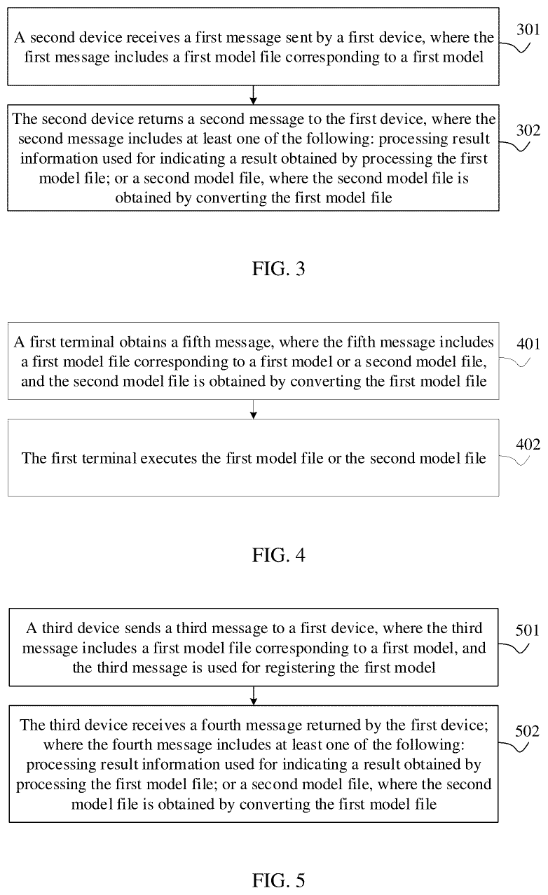

FIG. 3 is a second schematic flowchart of a model processing method according to an embodiment of this application. As shown in FIG. 3, the method includes steps 301 and 302.

Step 301: A second device receives a first message sent by a first device, where the first message includes a first model file corresponding to a first model.

Optionally, the first message may be, for example, a model check request message for indicating the second device to verify the first model to check whether the first model can be used properly on the second device. The first model may be an AI model, an ML model, or the like.

Optionally, the first device is used for storing first models trained by model training parties, and the first device includes at least one of the following items: (a) a model store; (b) a NEF; (c) an ADRF; or (d) an NRF.

Optionally, the second device is used for verifying the first model, and the second device a UE vendor server.

It should be noted that the first message includes the first model file corresponding to the first model. Since different UE vendors have their own optimization methods for models, after the first device sends the first message including the first model file to the second device, the second device needs to process the first model file of the first model, such as checking, testing, confirming, checking out, or verifying, so as to determine whether the first model file can be used properly on the second device.

It should be noted that the terminal device associated with the second device can be understood as a terminal device produced, developed, or sold by the UE vendor corresponding to the UE vendor server.

For example, the second device verifies the encoding format of the first model file. Correspondingly, the second device may support the encoding format of the first model file, or may not support the encoding format of the first model file.

Step 302: The second device returns a second message to the first device, where the second message includes at least one of the following: processing result information used for indicating a result obtained by processing the first model file; or a second model file, where the second model file is obtained by converting the first model file.

Optionally, the second model file can be correctly executed on the first terminal associated with the second device.

Optionally, the second message may further include first indication information for indicating a manufacturer associated with the second device. The first indication information may be, for example, a vendor ID.

Correspondingly, when the second device returns the second message to the first device, the first device can determine, based on the first indication information, which second device the second message comes from.

In this embodiment of this application, the second device receives a first message sent by the first device, where the first message includes a first model file corresponding to a first model; and then the second device returns a second message to the first device, where the second message includes at least one of processing result information or a second model file, the processing result information is used for indicating a result obtained by processing the first model file, and the second model file is obtained by converting the first model file. Based on the processing result information, the first device can learn whether the first model file can be correctly executed in the second device and a terminal associated with the second device. Based on that the second message includes the second model file, the first device can determine that the second model file can be correctly executed in the second device and the terminal associated with the second device. Therefore, the second device returning the processing result information or the second model file to the first device can enable the first device to determine whether the first model can be correctly executed in the terminal associated with the second device, so as to avoid a problem that the terminal cannot properly use the model.

Optionally, the first message further includes a first identifier, and the first identifier is assigned to the first model by the first device.

In other words, the first message received by the second device from the first device includes the first identifier of the first model, ensuring that the first device and the second device have a consistent understanding on the first model.

Optionally, the first message further includes first information, where the first information includes at least one of the following:
(a) information for indicating a version number of the first model;
(b) information for indicating at least one parameter corresponding to the first model;
(c) information for indicating a use condition or a use scenario of the first model;
(d) information for indicating at least one function supported by the first model;
(e) information for indicating a generating device or a training device of the first model; or
(f) information for indicating a using device of the first model.

Optionally, after returning the second message to the first device, the second device needs to send to the first terminal information that is associated with the first model and that has been successfully tested by the second device, so as to ensure that the first model can be correctly executed on the first terminal. This can be implemented through the following step:

The second device sends a fifth message to a first terminal, where the fifth message includes the first model file or the second model file.

For example, in a case that the fifth message includes the first model file, it indicates that the second device directly sends the first model file, which can be correctly executed on the second device, to the first terminal. If the fifth message includes the second model file, it indicates that the first model file cannot be correctly executed on the second device, and after the second device converts the first model file, the second model file that can be correctly executed on the second device is sent to the first terminal.

Optionally, the fifth message further includes at least one of the following: a first identifier; or first information, where the first information includes at least one of the following:
(a) information for indicating a version number of the first model;
(b) information for indicating at least one parameter corresponding to the first model;
(c) information for indicating a use condition or a use scenario of the first model;
(d) information for indicating at least one function supported by the first model;
(e) information for indicating a generating device or a training device of the first model; or
(f) information for indicating a using device of the first model.

Optionally, the sending, by the second device, a fifth message to a first terminal includes at least one of the following manners:

Manner 1: the second device sends the fifth message to the first terminal in a case that the first terminal has registered with the second device.

For example, the first terminal first registers with the UE vendor server, and then UE vendor server can directly send the fifth message to the first terminal.

Manner 2: the second device sends an eighth message to the first terminal in a case that a third request is received from the first terminal, where the third request is used to query whether there is an undownloaded or updated model file, and the eighth message is used for indicating that there is an undownloaded or updated model file in the second device; and sending, by the second device, the fifth message to the first terminal in a case that a fourth request is received from the first terminal, where the fourth request is used for obtaining the fifth message.

Optionally, the third request includes second indication information for indicating the manufacturer corresponding to the first terminal, such as a vendor ID or information of the terminal model. The second indication information is carried in the IMEI of the first terminal.

The UE vendor server can push the fifth message to the first terminal through an application layer, for example, via an over the top (OTT).

For example, the first terminal periodically requests the UE vendor server to check where there is an undownloaded or updated model file, and if there is an undownloaded or updated model file in the UE vendor server, notifies the first terminal; and then the first terminal retrieves the model file from the UE vendor server based on the notification.

Manner 3: The second device sends the fifth message to the first terminal in a case that a ninth message is received from the first terminal, where the ninth message includes at least one of the following: a first identifier; information for indicating a version number of the first model; or second indication information for indicating information about a manufacturer or terminal model corresponding to the first terminal.

For example, in a scenario where the network side indicates the first terminal to execute the first model, the network side may first send a model identifier list (model ID list) it supports to the first terminal, where the model ID list includes the first identifier. The first terminal compares its supported model ID list with a model ID list supported by the network side. If the first terminal determines that the first terminal lacks the first identifier, the first terminal sends a ninth message to the UE vendor server, requesting the UE vendor server to send the fifth message to the first terminal.

The ninth message includes at least one of the following: a first identifier; information for indicating a version number of the first model, such as a version ID; or second indication information for indicating the manufacturer corresponding to the first terminal, such as a vendor ID or information about the terminal model, where the second indication information is carried in the IMEI of the first terminal.

Optionally, the ninth message may further carry model capability information supported by the first terminal, and the UE vendor server may send the fifth message to the first terminal based on the model capability information supported by the first terminal.

FIG. 4 is a schematic flowchart of a model execution method according to an embodiment of this application. As shown in FIG. 4, the method includes steps 401 and 402.

Step 401: A first terminal obtains a fifth message, where the fifth message includes a first model file corresponding to a first model or a second model file, and the second model file is obtained by converting the first model file.

Step 402: The first terminal executes the first model file or the second model file.

It should be noted that if the fifth message includes the first model file, it indicates that the first model file can be used properly on a second device associated with the first terminal.

In a case that the fifth message includes the second model file, it indicates that the first model file cannot be used properly on the second device associated with the first terminal, and the second device generates a second model file that can be used properly on the second device by converting the first model file, ensuring that the second model file can be used properly on the first terminal.

Optionally, the second model file is obtained by the second device associated with the first terminal by converting the first model file, and the second model file can be correctly executed on the first terminal associated with the second device.

By executing the first model file or the second model file, the first terminal avoids incompatibility issues when using the model.

In this embodiment of this application, the first terminal obtains a fifth message, where the fifth message includes a first model file or a second model file corresponding to the first model, and the second model file is obtained by converting the first model file. Through execution of the first model file or the second model file by the first terminal, it can be ensured that the first model file or the second model file can be correctly executed on the first terminal, so as to avoid a problem that the first terminal cannot properly use the model.

Optionally, the fifth message further includes at least one of the following:

a first identifier for identifying the first model; or first information, where the first information includes at least one of the following:
(a) information for indicating a version number of the first model;
(b) information for indicating at least one parameter corresponding to the first model;
(c) information for indicating a use condition or a use scenario of the first model;
(d) information for indicating at least one function supported by the first model;
(e) information for indicating a generating device or a training device of the first model; or
(f) information for indicating a using device of the first model.

In the foregoing implementation, the first terminal obtains the first identifier, so that when the network side indicates the first terminal to execute the first model, the first terminal and the network side have a consistent understanding. Since the first information has been successfully tested by the second device associated with the first terminal, it can be ensured that the first terminal can correctly execute the first information.

Optionally, the first terminal obtaining the fifth message can be implemented through at least one of manner 1 or manner 2.

Manner 1: the first terminal receives the fifth message from the first device.

Optionally, the first device is used for storing first models trained by model training parties, and the first device includes at least one of the following items: (a) a model store; (b) a NEF; (c) an ADRF; or (d) an NRF.

For example, the first terminal first registers with the model store, and then the model store can directly send the fifth message to the first terminal.

Manner 2: the first terminal sends a first request to the first device; the first terminal receives a sixth message from the first device, where the first request is used to query whether there is an undownloaded or updated model file, and the sixth message is used to indicate that there is an undownloaded or updated model file in the first device; the first terminal sends a second request to the first device, where the second request is used for obtaining the fifth message; and the first terminal receives the fifth message from the first device.

Optionally, the first request includes second indication information for indicating the manufacturer corresponding to the first terminal, such as a vendor ID or information of the terminal model. The second indication information is carried in the IMEI of the first terminal.

For example, the first terminal periodically requests the model store to check where there is an undownloaded or updated model file, and if there is an undownloaded or updated model file in the model store, notifies the first terminal; and then the first terminal retrieves the model file from the model store based on the notification.

Optionally, the first terminal obtaining the fifth message can alternatively be implemented through at least one of manner 3 or manner 4.

Manner 3: The first terminal receives the fifth message from the second device.

For example, the first terminal first registers with the UE vendor server, and then UE vendor server can directly send the fifth message to the first terminal.

Manner 4: the first terminal sends a third request to the second device; receiving, by the first terminal, an eighth message from the second device, where the third request is used to query whether there is an undownloaded or updated model file, and the eighth message is used to indicate that there is an undownloaded or updated model file in the second device; sending, by the first terminal, a fourth request to the second device, where the fourth request is used for obtaining the fifth message; and receiving, by the first terminal, the fifth message from the second device.

Optionally, the third request includes second indication information for indicating the manufacturer corresponding to the first terminal, such as a vendor ID or information of the terminal model. The second indication information is carried in the IMEI of the first terminal.

For example, the first terminal periodically requests the UE vendor server to check where there is an undownloaded or updated model file, and if there is an undownloaded or updated model file in the UE vendor server, notifies the first terminal; and then the first terminal retrieves the model file from the UE vendor server based on the notification.

Optionally, the first terminal obtaining the fifth message can alternatively be implemented through at least one of manner 5 or manner 6.

Manner 5: The first terminal receives the fifth message from the third device.

Optionally, the third device includes at least one of the following: (a) a core network device; (b) an access network device; (c) a target server device, such as a 3rd server; or (d) a second terminal, where the second terminal may be the same as the first terminal, or may be different from the first terminal.

For example, the first terminal registers with the core network device first, and then the core network device may directly send the fifth message to the first terminal.

Manner 6: the first terminal sends a fifth request to the third device; receiving, by the first terminal, a tenth message from the third device, where the fifth request is used to query whether there is an undownloaded or updated model file in the third device, and the tenth message is used to indicate that there is an undownloaded or updated model file in the third device; sending, by the first terminal, a sixth request to the third device, where the sixth request is used for obtaining the fifth message; and receiving, by the first terminal, the fifth message from the third device.

Optionally, the fifth request includes second indication information for indicating the manufacturer corresponding to the first terminal, such as a vendor ID or information of the terminal model. The second indication information is carried in the IMEI of the first terminal.

For example, the first terminal periodically requests the core network device to check where there is an undownloaded or updated model file, and if there is an undownloaded or updated model file in the core network device, notifies the first terminal; and then the first terminal retrieves the model file from the core network device based on the notification.

Optionally, obtaining the fifth message by the first terminal can alternatively be implemented through manner 7. Manner 7 includes the following steps [1] and [2]:
Step [1]: The first terminal sends an eleventh message to the third device.
Step [2]: The first terminal receives the fifth message from the third device.

The eleventh message includes at least one of the following:
(a) second indication information; or
(b) a first model list, including an identifier of at least one model supported by the first terminal or at least one version number.

In this embodiment of the application, the first terminal sends at least one of the following to the third device: manufacturer information corresponding to the first terminal, terminal model information, an identifier (model ID) of at least one model supported by the first terminal, or a version number (version ID) of at least one model supported by the first terminal. The third device can select, based on the foregoing information, information associated with the first model and supported by the first terminal and include it in the fifth message for sending to the first terminal.

Optionally, the eleventh message may further carry model capability information supported by the first terminal, and the third device may send a fifth message to the first terminal based on the model capability information supported by the first terminal.

Optionally, the eleventh message is carried by at least one of the following messages: a radio resource control (RRC) message; or a non-access stratum (NAS) message.

In practical applications, the first terminal may send the eleventh message to the third device in a plurality of manners. For example, the first terminal may send the eleventh message to the third device via a radio capability at an RRC layer. For another example, the first terminal may send the eleventh message to an access and mobility management function (AMF) through a 5th generation mobile communication technology (5G) mobility management (MM) capability. Then the AMF forwards the eleventh message to the third device.

Optionally, obtaining the fifth message by the first terminal can alternatively be implemented through manner 8. Manner 8 includes the following steps [1] and [2]:
Step [1]: The first terminal receives a twelfth message from a third device, where the twelfth message is used to indicate a second model list, and the second model list includes at least one of the following: an identifier of at least one model supported by the third device or at least one version number.
Step [2]: The first terminal obtains the fifth message based on the first model list and the second model list in a case that it is determined that a first identifier or information indicating a version number of the first model is present in the second model list but not in the first model list.

In this embodiment of this application, the first terminal first needs to receive the twelfth message from the third device, where the twelfth message indicates the second model list, and the second model list includes an identifier of at least one model supported by the third device, for example, a model ID list, and at least one version number, for example, version ID list.

Optionally, the twelfth message is carried by at least one of the following messages: (a) a system information block (SIB) message; (b) an RRC message; or (c) a NAS message.

After receiving the twelfth message, the first terminal compares the first model list with the second model list, where the first model list includes an identifier of at least one model supported by the first terminal, such as a model ID list, and at least one version number, such as a version ID list.

If the first terminal determines that the first identifier or information indicating the version number of the first model such as a version ID is present in the second model list but not in the first model list, the first terminal obtains the fifth message based on missing information in the first model list. In other words, if the second model list includes a model ID or version ID not present in the first model list, or the first terminal determines, based on the second model list, that a model ID or version ID not saved by the first terminal is present in the first model list, the first terminal obtains the fifth message.

Optionally, in manner 8, if the first terminal determines that the first identifier or information indicating the version number of the first model is present in the second model list but not in the first model list, there are a plurality of manners of obtaining the fifth message, which includes the following manners (manner 8.1 to manner 8.3):

Manner 8.1: the first terminal sends a seventh message to a first device based on the first identifier or the information for indicating the version number of the first model, where the seventh message includes at least one of the first identifier, the information for indicating the version number of the first model, or second indication information; and the first terminal receives the fifth message from the first device.

In this embodiment of this application, the first terminal can obtain the fifth message from the model store.

For example, in a scenario where the network side indicates the first terminal to execute the first model, the network side may first send a model identifier list (model ID list) it supports to the first terminal, where the model ID list includes the first identifier. The first terminal compares its supported model ID list with a model ID list supported by the network side. If the first terminal determines that the first terminal lacks the first identifier, the first terminal sends a seventh message to the model store, requesting the model store to send the fifth message to the first terminal.

The seventh message includes at least one of the following: a first identifier; information for indicating a version number of the first model, such as a version ID; or second indication information for indicating the manufacturer corresponding to the first terminal, such as a vendor ID or information about the terminal model, where the second indication information is carried in the IMEI of the first terminal.

Optionally, the seventh message may further carry model capability information supported by the first terminal, and the model store may send the fifth message to the first terminal based on the model capability information supported by the first terminal.

Manner 8.2: the first terminal sends a ninth message to a second device based on the first identifier or the information for indicating the version number of the first model, where the ninth message includes at least one of the first identifier, the information for indicating the version number of the first model, or the second indication information; and the first terminal receives the fifth message from the second device.

In this embodiment of this application, the first terminal can obtain the fifth message from the UE vendor server.

For example, if the first terminal determines that the first terminal lacks the first identifier, it sends a ninth message to the UE vendor server to request the UE vendor server to send the fifth message to the first terminal.

The ninth message includes at least one of the following: a first identifier; information for indicating a version number of the first model, such as a version ID; or second indication information for indicating the manufacturer corresponding to the first terminal, such as a vendor ID or information about the terminal model, where the second indication information is carried in the IMEI of the first terminal.

Optionally, the ninth message may further carry model capability information supported by the first terminal, and the UE vendor server may send the fifth message to the first terminal based on the model capability information supported by the first terminal.

Manner 8.3: the first terminal sends a thirteenth message to a third device based on the first identifier or the information for indicating the version number of the first model, where the thirteenth message includes at least one of the first identifier, the information for indicating the version number of the first model, or second indication information; and the first terminal receives the fifth message from the third device.

In this embodiment of this application, the first terminal may obtain the fifth message from the third device.

For example, if the first terminal determines that the first terminal lacks the first identifier, the first terminal sends the thirteenth message to the core network device to request the core network device to send the fifth message to the first terminal.

The thirteenth message includes at least one of the following: a first identifier; information for indicating a version number of the first model, such as a version ID; or second indication information for indicating the manufacturer corresponding to the first terminal, such as a vendor ID or information about the terminal model, where the second indication information is carried in the IMEI of the first terminal.

Optionally, the thirteenth message may further carry model capability information supported by the first terminal, and the UE vendor server may send the fifth message to the first terminal based on the model capability information supported by the first terminal.

Optionally, in the foregoing implementation, after obtaining the fifth message from the first device or the second device, the first terminal needs to send the first model list supported by the first terminal to the third device, so that the third device sends an activation message for the first model to the first terminal, to implement correct execution of the first model by the first terminal. This can be implemented through the following step:

The first terminal sends a fifteenth message to the third device, where the fifteenth message is used to indicate a first model list, where the first model list includes an identifier of at least one model supported by the first terminal or at least one version number.

In this embodiment of this application, the first terminal sends the first model list to the third device, so that the third device can determine, based on an identifier of at least one model supported by the first terminal or at least one version number, whether the first terminal meets a trigger condition of the model and whether the first terminal supports a to-be-activated parameter. In a case that the third device determines a use condition and a to-be-activated parameter of the model supported by the first terminal, it may send to the first terminal an activation indication for activating the first model.

In practical applications, the first terminal may send the fifteenth message to the third device in a plurality of manners. For example, the first terminal may send the fifteenth message to the third device via a radio capability at an RRC layer. For another example, the first terminal may send the fifteenth message to an AMF through a 5G MM capability. Then the AMF forwards the fifteenth message to the third device.

Optionally, the first terminal activates the first model, which can be implemented through the following steps [1] and [2]:
Step [1]: The first terminal receives a fourteenth message from the third device.
Step [2]: The first terminal activates the first model based on the fourteenth message.

Optionally, the fourteenth message includes at least one of the following:
(a) a first identifier;
(b) information indicating a version number of the first model, such as a version ID; or
(c) at least one to-be-activated parameter.

In this embodiment of this application, based on the first identifier or the information indicating the version number of the first model, the third device ensures that the model to be activated by the third device is consistent with the model executed by the first terminal, avoiding inconsistencies in understanding the first model between the first terminal and the third device.

The third device needs to determine whether the first terminal meets a trigger condition of the model and whether the first terminal supports a to-be-activated parameter, where the trigger condition of the model may include, for example, a use condition of the model, such as a time condition, a location condition, a channel condition, a scenario condition, a speed condition, a range of accessible cells, or a cell ID list.

If the third device determines that the first terminal supports the use condition and the to-be-activated parameter of the model, the third device sends the fourteenth message to the first terminal. Correspondingly, the first terminal activates the first model based on the fourteenth message, thereby implementing correct execution of the first model by the first terminal.

FIG. 5 is a schematic flowchart of a model registration method according to an embodiment of this application. As shown in FIG. 5, the method includes steps 501 and 502.

Step 501: A third device sends a third message to a first device, where the third message includes a first model file corresponding to a first model, and the third message is used for registering the first model.

Step 502: The third device receives a fourth message returned by the first device; where the fourth message includes at least one of the following: processing result information used for indicating a result obtained by processing the first model file; or a second model file, where the second model file is obtained by converting the first model file.

Optionally, the third device generates a model or trains a model to obtain the first model. After obtaining the first model, the third device sends a third message to the first device, where the third message may be, for example, a registration request or a publish request, and the third message is used for registering the first model to the first device, so that the first device can store the first model.

The third device then receives the fourth message returned by the first device, where the fourth message may be, for example, a registration or publish response message, indicating that the first model has been registered to the first device, or that the first device has stored the first model.

Optionally, the second model file can be correctly executed on the first terminal associated with the second device.

Optionally, the first device includes at least one of the following: (a) a model store; (b) a NEF; (c) an ADRF; or (d) an NRF.

Optionally, the second device includes a UE vendor server.

Optionally, the third device includes at least one of the following: (a) a core network device; (b) an access network device; (c) a target server device; or (d) a second terminal.

In this embodiment of this application, the third device sends a third message to the first device, so that the first device registers the first model based on the first model file corresponding to the first model included in the third message. Then the third device receives the processing result information and the second model file that are returned by the first device, where the processing result information is used to indicate a result obtained by processing the first model file, and the second model file is obtained by converting the first model file. The third device can learn based on the processing result information whether the first model file can be correctly executed in the second device and the terminal associated with the second device. Based on that the second message includes the second model file, the third device can determine that the second model file can be correctly executed in the second device and the terminal associated with the second device. Therefore, based on the processing result information or the second model file, the third device can determine whether the first model can be correctly executed in the terminal associated with the second device, so as to avoid a problem that the terminal cannot properly use the model.

Optionally, the third message further includes first information, where the first information includes at least one of the following:
(a) information for indicating a version number of the first model;
(b) information for indicating at least one parameter corresponding to the first model;
(c) information for indicating a use condition or a use scenario of the first model;
(d) information for indicating at least one function supported by the first model;
(e) information for indicating a generating device or a training device of the first model; or
(f) information for indicating a using device of the first model.

Optionally, the fourth message further includes at least one of the following:
(a) a first identifier;
(b) the first model file;
(c) first information; or
(d) first indication information for indicating information about a manufacturer corresponding to the second device.

Optionally, after receiving the fourth message returned by the first device, the third device needs to perform the following step:

The third device sends a fifth message to a first terminal, where the fifth message includes the first model file or the second model file.

In this embodiment of this application, the third device sends the first model file or the second model file to the first terminal, so that the first model file can be correctly executed in the terminal or the second model file can be correctly executed in the terminal, thereby avoiding incompatibility issues when the terminal uses the model.

Optionally, the fifth message further includes at least one of the following: a first identifier; or first information, where the first information includes at least one of the following:
(a) information for indicating a version number of the first model;
(b) information for indicating at least one parameter corresponding to the first model;
(c) information for indicating a use condition or a use scenario of the first model;
(d) information for indicating at least one function supported by the first model;
(e) information for indicating a generating device or a training device of the first model; or
(f) information for indicating a using device of the first model.

Optionally, the third device sending the fifth message to the first terminal can be implemented in the following manner 1 or manner 2:

Manner 1: The third device sends the fifth message to the first terminal in a case that the first terminal has registered with the third device.

For example, the first terminal registers with the core network device first, and then the core network device may directly send the fifth message to the first terminal.

Manner 2: The third device sends a tenth message to the first terminal in a case that a fifth request is received from the first terminal, where the fifth request is used to query whether there is an undownloaded or updated model file in the third device, and the tenth message is used for indicating that there is an undownloaded or updated model file in the third device; and the third device sends the fifth message to the first terminal in a case that a sixth request is received from the first terminal, where the sixth request is used for obtaining the fifth message.

Optionally, the fifth request includes second indication information for indicating information about a manufacturer or terminal model corresponding to the first terminal.

For example, the first terminal periodically requests the core network device to check where there is an undownloaded or updated model file, and if there is an undownloaded or updated model file in the core network device, notifies the first terminal; and then the first terminal retrieves the model file from the core network device based on the notification.

Optionally, the third device may send the fifth message to the first terminal in the following manner 3, including steps [1] and [2]:
Step [1]: The third device receives an eleventh message from the first terminal.
Step [2]: The third device sends a fifth message to the first terminal based on the eleventh message.

The eleventh message includes at least one of the following:
(a) second indication information; or
(b) a first model list, including an identifier of at least one model supported by the first terminal or at least one version number.

In this embodiment of the application, the third device receives the eleventh message sent by the first terminal, and the third device can select, based on the eleventh message, information associated with the first model and supported by the first terminal and include it in the fifth message for sending to the first terminal.

Optionally, the eleventh message is carried by at least one of the following messages: an RRC message; or a NAS message.

Optionally, the third device may send the fifth message to the first terminal in the following manner 4, including steps [1] and [2]:
Step [1]: The third device receives a thirteenth message from the first terminal.
Step [2]: The third device sends the fifth message to the first terminal based on the thirteenth message; where the thirteenth message includes at least one of the following: a first identifier, information for indicating a version number of the first model, or second indication information.

For example, in a scenario where the network side indicates the first terminal to execute the first model, the first terminal compares its supported model ID list with a model ID list supported by the network side. If the first terminal determines that the first terminal lacks the first identifier, the first terminal sends the thirteenth message to the core network device to request the core network device to send the fifth message to the first terminal.

Optionally, the second indication information is carried in the IMEI.

Optionally, before the third device receives the thirteenth message from the first terminal, the third device needs to perform the following step:

The third device sends a twelfth message to the first terminal, where the twelfth message is used to indicate a second model list, and the second model list includes at least one of the following: an identifier of at least one model supported by the third device or at least one version number.

In this embodiment of this application, the third device needs to send the second model list it supports to the first terminal, so that the first terminal can compare its supported first model list with the second model list supported by the third device, and when the first terminal determines that it lacks the first identifier in the second model list, sends the thirteenth message to the third device to request the third device to send the fifth message to the first terminal.

Optionally, the twelfth message is carried by at least one of the following messages: (1) a SIB message; (2) an RRC message; or (3) a NAS message.

Optionally, in a case that the first terminal obtains the fifth message from the first device or the second device, the first terminal needs to send the first model list supported by the first terminal to the third device, so that the third device may send an activation message of the first model to the first terminal based on the first model list, so as to implement correct execution of the first model by the first terminal. This can be implemented by the following step:

The third device receives a fifteenth message from the first terminal, where the fifteenth message is used to indicate a first model list.

In this embodiment of this application, the third device receives the first model list supported by the first terminal, so that the third device can determine, based on the identifier of at least one model supported by the first terminal or at least one version number, whether the first terminal meets a trigger condition of the model and whether the first terminal supports a to-be-activated parameter. In a case that the third device determines a use condition and a to-be-activated parameter of the model supported by the first terminal, it may send to the first terminal an activation indication for activating the first model.

Optionally, the fifteenth message is carried by at least one of the following messages: an RRC message; or a NAS message.

Optionally, the first device indicating activation of the first model to the first terminal can be implemented by the following step:

The third device sends a fourteenth message to the first terminal in a case that the first terminal meets a trigger condition of the first model and the first terminal supports at least one to-be-activated parameter, where the fourteenth message is used for indicating to activate the first model.

Optionally, the fourteenth message includes at least one of the following:
(a) a first identifier;
(b) information for indicating a version number of the first model; or
(c) at least one to-be-activated parameter.

In this embodiment of this application, based on the first identifier or the information indicating the version number of the first model, the third device ensures that the model to be activated by the third device is consistent with the model executed by the first terminal, avoiding inconsistencies in understanding the first model between the first terminal and the third device.

The third device needs to determine whether the first terminal meets a trigger condition of the model and whether the first terminal supports a to-be-activated parameter, where the trigger condition of the model may include, for example, a use condition of the model, such as a time condition, a location condition, a channel condition, a scenario condition, a speed condition, a range of accessible cells, or a cell ID list.

If the third device determines that the first terminal supports the use condition and the to-be-activated parameter of the model, the third device sends the fourteenth message to the first terminal. Correspondingly, the first terminal activates the first model based on the fourteenth message, thereby implementing correct execution of the first model by the first terminal.

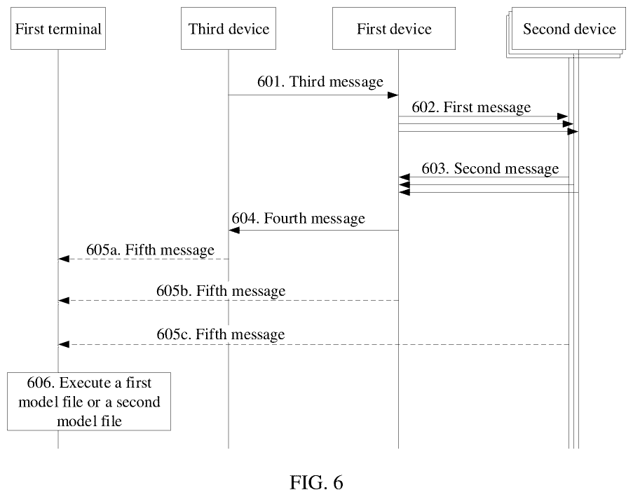

FIG. 6 is a first schematic diagram of signaling interaction of a model processing, registration and execution method according to an embodiment of this application. As shown in FIG. 6, it includes the following steps 601 to 606, and step 605 includes steps 605a, 605b, and 605c:

Step 601: A third device sends a third message to a first device, where the third message includes a first model file corresponding to a first model, and the third message is used for registering the first model.

Optionally, the first device includes at least one of the following: (a) a model store; (b) a NEF; or (c) an ADRF. The third device includes at least one of the following: a core network device; an access network device; a target server device; or a second terminal.

Step 602: The first device sends a first message to at least one second device, where the first message includes a first model file.

Optionally, the second device includes a UE vendor server.

Step 603: The second device returns a second message to the first device, where the second message includes at least one of the following: processing result information used for indicating a result obtained by processing the first model file; or a second model file, where the second model file is obtained by converting the first model file.

Step 604: The third device receives a fourth message returned by the first device; where the fourth message includes at least one of the following: processing result information or a second model file.

Step 605a: The first terminal obtains a fifth message from the third device.

Step 605b: The first terminal obtains a fifth message from the first device.

Step 605c: The first terminal obtains a fifth message from the second device.

It should be noted that the first terminal may perform at least one of steps 605a, 605b, or 605c.

Optionally, the fifth message includes a first model file corresponding to the first model or a second model file.

Step 606: The first terminal executes the first model file or the second model file.

In this embodiment of this application, the third device sends a third message to the first device, so that the first device can register the first model. Then the first device sends a first message to different second devices, requesting each second device to test the first model separately, and then receives a second message from each second device. Based on the processing result information included in the second message or the second model file, it can be determined that the first model file can be correctly executed in the terminal, or the second model file can be executed correctly in the terminal. The first terminal obtains and executes the first model file or the second model file, thereby avoiding incompatibility issues when the first terminal uses the model.

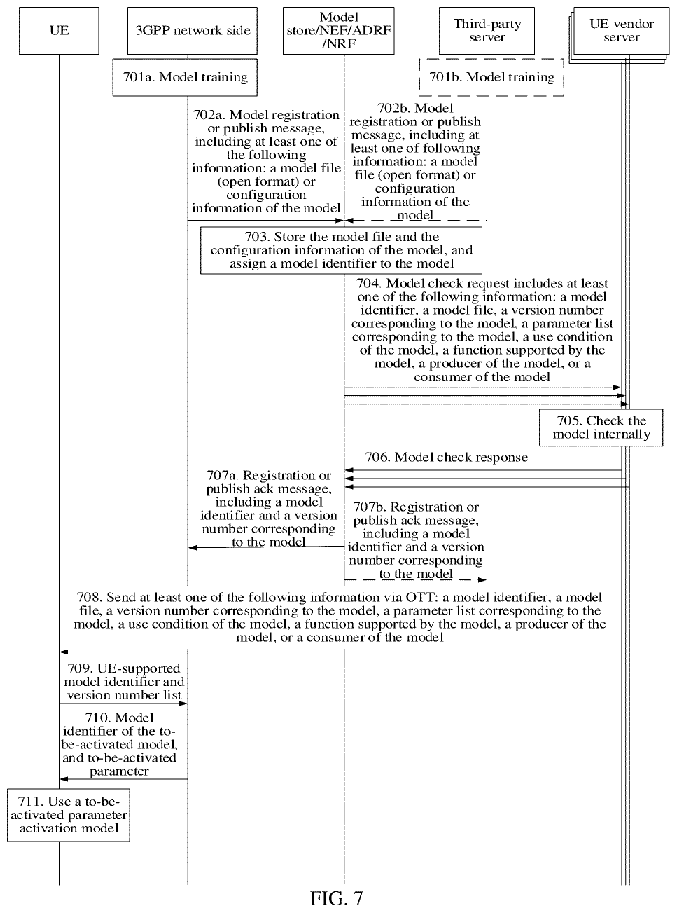

FIG. 7 is a second schematic diagram of signaling interaction of a model processing, registration and execution method according to an embodiment of this application. As shown in FIG. 7, it includes steps 701 to 711. Step 701 includes steps 701a and 701b, step 702 includes steps 702a and 702b, and step 707 includes steps 707a and 707b. FIG. 7 shows an implementation scheme in which a UE vendor server sends a model file to UE.

Step 701a: A 3GPP network side performs model training.

Step 701b: A third-party server performs model training.

It should be noted that in practice, only step 701a or step 701b may be executed, which is not limited in this application. Optionally, the model may be an AI model, an ML model, or the like.

Step 702a: The 3GPP network side sends a model registration or publish message to the model store, where the model registration or publish message is used to register or publish a trained model to the model store.

Step 702b: The third-party server sends a model registration or publish message to the model store, where the model registration or publish message is used to register or publish a trained model to the model store.

It should be noted that step 702a corresponds to step 701a, and step 702b corresponds to step 701b, that is, in a case that the 3GPP network side executes step 701a, the 3GPP network side executes step 702a; while in a case that the third-party server executes step 701b, the third-party server executes step 702b.

Optionally, the model registration or publish message includes at least one of the following information:
a model file (open format) or configuration information of the model, where the configuration information of the model includes at least one of the following:
(a) a version number corresponding to the model, (b) a parameter list corresponding to the model, (c) a use condition of the model, (d) a function supported by the model, (e) a producer of the model, or (f) a consumer of the model.

Step 703: The model store stores the model file and the configuration information of the model, and assigns a globally unique model identifier to the model.

Step 704: The model store sends a model check request to each UE vendor server.

For example, the model check request includes at least one of the following information:
(a) a model identifier, (b) a model file, (c) a version number corresponding to the model, (d) a parameter list corresponding to the model, (e) a use condition of the model, (f) a function supported by the model, (g) a producer of the model, or (h) a consumer of the model.

Step 705: Each UE vendor server checks the model internally.

It should be noted that checking the model refers to testing or correspondingly transforming parameters that can be used in the model.

Conversion means converting from a model mode not supported by the UE vendor (for example, an encoding format of the model file) to a model mode supported by the UE vendor.

Step 706: Each UE vendor server sends a model check response to the model store, including a conversion result and a test result.

It should be noted that the test result includes a test success result and a test failure result.

Step 707a: The model store sends a model registration or publish ack message to the 3GPP network side, including a registration or publish result.

Step 707b: The model store sends a model registration or publish ack message to the third-party server, including a registration result or publish result.

It should be noted that in practice, the model store can execute both steps 707a and 707b, or only step 707a or only step 707b. In a case that the model store executes steps 707a and 707b, steps 707a and 707b can be executed simultaneously, or step 707a can be executed first and then step 707b is executed, or step 707b can be executed first and then step 707a is executed, which is not limited in this application.

Optionally, the registration result or publish result includes a model identifier and a version number corresponding to the model.

Step 708: The UE vendor server sends the model identifier, the model file, the version number corresponding to the model, the parameter list corresponding to the model, the usable condition of the model, the function supported by the model, the producer of the model, and the consumer of the model to the UE through the application layer, such as the OTT.

Optionally, the model file includes a model file before the conversion by the UE vendor server or a model file obtained after the conversion by the UE vendor server.

The push manner includes: the UE periodically requests the UE vendor server to check for a new model file; when the UE vendor server has a new model file, it notifies the UE; then the UE retrieves the new model file from the UE vendor server based on the notification.

Step 709: The UE indicates a model capability, that is, the UE sends a UE-supported model identifier and a version number list to the 3GPP network side.

For example, the UE may send, to the 3GPP network side such as a base station, the UE-supported model identifier and the version number list via a radio capability at the RRC layer;

or the UE may send the UE-supported model identifier and the version number list to the AMF via a 5G MM capability, and then the AMF sends it to the 3GPP network side.

Step 710: The 3GPP network side such as the access network device/core network device performs model activation management in a case of determining that the UE meets a trigger condition of the model and the UE supports a to-be-activated parameter.

That is, the 3GPP network side sends a message for activating the model to the UE, where the message carries at least one of the following information: (a) a model identifier of the to-be-activated model; or (b) a to-be-activated parameter.

Step 711: The UE uses a to-be-activated parameter activation model.

For example, the UE executes the model based on a model identifier of the to-be-activated model and the to-be-activated parameter, and obtains a result.

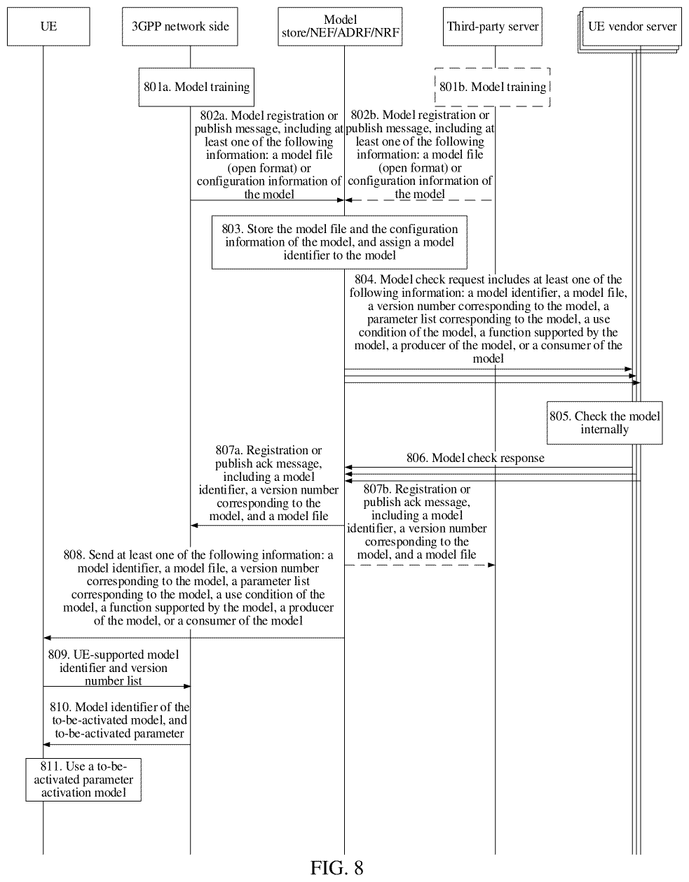

FIG. 8 is a third schematic diagram of signaling interaction of a model processing, registration and execution method according to an embodiment of this application. As shown in FIG. 8, it includes steps 801 to 811. Step 801 includes steps 801a and 801b, step 802 includes steps 802a and 802b, and step 807 includes steps 807a and 807b. FIG. 8 shows an implementation scheme in which a model store sends a model file to UE.

Step 801a: A 3GPP network side performs model training.

Step 801b: A third-party server performs model training.

It should be noted that in practice, only step 801a or step 801b may be executed, which is not limited in this application. Optionally, the model may be an AI model, an ML model, or the like.

Step 802a: The 3GPP network side sends a model registration or publish message to the model store, where the model registration or publish message is used to register or publish a trained model to the model store.

Step 802b: The third-party server sends a model registration or publish message to the model store, where the model registration or publish message is used to register or publish a trained model to the model store.

It should be noted that step 802a corresponds to step 801a, and step 802b corresponds to step 801b, that is, in a case that the 3GPP network side executes step 801a, the 3GPP network side executes step 802a; while in a case that the third-party server executes step 801b, the third-party server executes step 802b.

Optionally, the model registration or publish message includes at least one of the following information:
a model file (open format) or configuration information of the model, where the configuration information of the model includes at least one of the following:
(a) a version number corresponding to the model, (b) a parameter list corresponding to the model, (c) a use condition of the model, (d) a function supported by the model, (e) a producer of the model, or (f) a consumer of the model.

Step 803: The model store stores the model file and the configuration information of the model, and assigns a globally unique model identifier to the model.

Step 804: The model store sends a model check request to each UE vendor server.

For example, the model check request includes at least one of the following information:
(a) a model identifier, (b) a model file, (c) a version number corresponding to the model, (d) a parameter list corresponding to the model, (e) a use condition of the model, (f) a function supported by the model, (g) a producer of the model, or (h) a consumer of the model.

Step 805: Each UE vendor server checks the model internally.

It should be noted that checking the model refers to testing or correspondingly transforming parameters that can be used in the model.

Conversion means converting from a model mode not supported by the UE vendor (for example, an encoding format of the model file) to a model mode supported by the UE vendor.

Step 806: Each UE vendor server sends a model check response to the model store, including a conversion result and a test result.

It should be noted that the test result includes a test success result and a test failure result.

Step 807a: The model store sends a model registration or publish ack message to the 3GPP network side, including a registration or publish result.

Step 807b: The model store sends a model registration or publish ack message to the third-party server, including a registration or publish result.

It should be noted that in practice, the model store can execute both steps 807a and 807b, or only step 807a or only step 807b. In a case that the model store executes steps 807a and 807b, steps 807a and 807b can be executed simultaneously, or step 807a can be executed first and then step 807b is executed, or step 807b can be executed first and then step 807a is executed, which is not limited in this application.

Optionally, the registration or publish result includes a model identifier, a version number corresponding to the model, and a model file.

Step 808: The model store sends the model identifier, the model file, the version number corresponding to the model, the parameter list corresponding to the model, the usable condition of the model, the function supported by the model, the producer of the model, and the consumer of the model to the UE.

Optionally, the model file includes a model file before the conversion by the UE vendor server or a model file obtained after the conversion by the UE vendor server.

For example, the model store may proactively push it to the UE, or the UE may periodically obtain it from the model store.

The UE periodically obtaining it from the model store can be implemented in the following manners: the UE periodically requests the model store to check for a new model file; when the model store has a new model file, it notifies the UE; then the UE retrieves the new model file from the model store based on the notification.

Step 809: The UE sends a UE-supported model identifier and a version number list to the 3GPP network side.

For example, the UE may send, to the 3GPP network side such as a base station, the UE-supported model identifier and the version number list via a radio capability at the RRC layer;

or the UE may send the UE-supported model identifier and the version number list to the AMF via a 5G MM capability, and then the AMF sends it to the 3GPP network side.

Step 810: The 3GPP network side such as the access network device/core network device performs model activation management in a case of determining that the UE meets a trigger condition of the model and the UE supports a to-be-activated parameter.

That is, the 3GPP network side sends a message for activating the model to the UE, where the message carries at least one of the following information:
(a) a model identifier of the to-be-activated model; or (b) a to-be-activated parameter.

Step 811: The UE uses a to-be-activated parameter activation model.

For example, the UE executes the model based on a model identifier of the to-be-activated model and the to-be-activated parameter, and obtains a result.

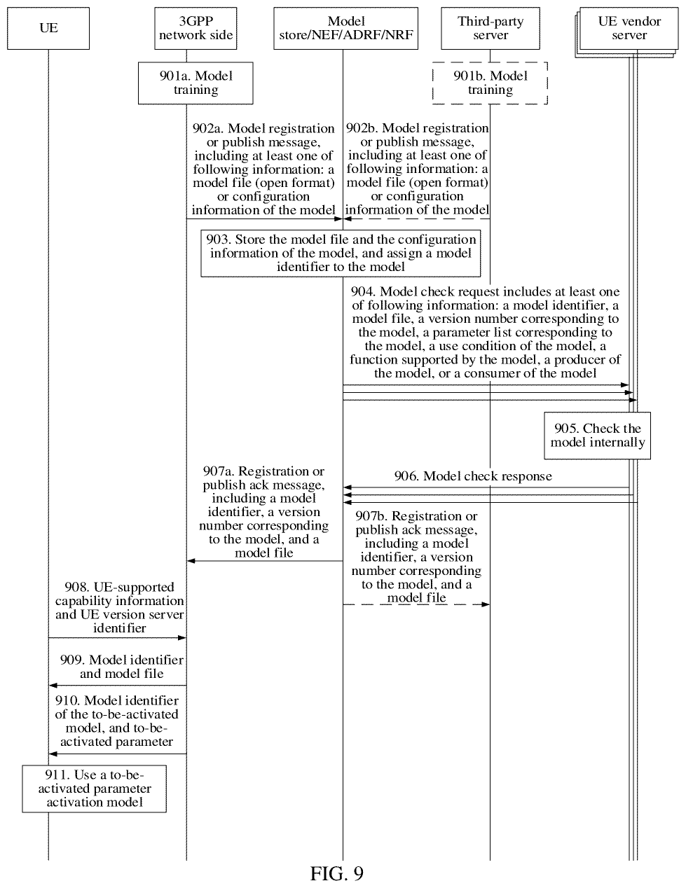

FIG. 9 is a fourth schematic diagram of signaling interaction of a model processing, registration and execution method according to an embodiment of this application. As shown in FIG. 9, it includes steps 901 to 911. Step 901 includes steps 901a and 901b, step 902 includes steps 902a and 902b, and step 907 includes steps 907a and 907b. FIG. 9 shows an implementation scheme in which a 3GPP network side sends a model file to UE.

Step 901a: The 3GPP network side performs model training.

Step 901b: A third-party server performs model training.

It should be noted that in practice, only step 901a or step 901b may be executed, which is not limited in this application. Optionally, the model may be an AI model, an ML model, or the like.

Step 902a: The 3GPP network side sends a model registration or publish message to the model store, where the model registration or publish message is used to register or publish a trained model to the model store.

Step 902b: The third-party server sends a model registration or publish message to the model store, where the model registration or publish message is used to register or publish a trained model to the model store.

It should be noted that step 902a corresponds to step 901a, and step 902b corresponds to step 901b, that is, in a case that the 3GPP network side executes step 901a, the 3GPP network side executes step 902a; while in a case that the third-party server executes step 901b, the third-party server executes step 902b.

The model registration or publish message includes at least one of the following information:

a model file (open format) or configuration information of the model, where the configuration information of the model includes at least one of the following:
(a) a version number corresponding to the model, (b) a parameter list corresponding to the model, (c) a use condition of the model, (d) a function supported by the model, (e) a producer of the model, or (f) a consumer of the model.

Step 903: The model store stores the model file and the configuration information of the model, and assigns a globally unique model identifier to the model.

Step 904: The model store sends a model check request to each UE vendor server.

For example, the model check request includes at least one of the following information:
(a) a model identifier, (b) a model file, (c) a version number corresponding to the model, (d) a parameter list corresponding to the model, (e) a use condition of the model, (f) a function supported by the model, (g) a producer of the model, or (h) a consumer of the model.

Step 905: Each UE vendor server checks the model internally.

It should be noted that checking the model refers to testing or correspondingly transforming parameters that can be used in the model.

Conversion means converting from a model mode not supported by the UE vendor (for example, an encoding format of the model file) to a model mode supported by the UE vendor.

Step 906: Each UE vendor server sends a model check response to the model store, including a conversion result and a test result.

It should be noted that the test result includes a test success result and a test failure result.

Step 907a: The model store sends a model registration or publish ack message to the 3GPP network side, including a registration or publish result.

Step 907b: The model store sends a model registration or publish ack message to the third-party server, including a registration or publish result.

It should be noted that in practice, the model store can execute both steps 907a and 907b, or only step 907a or only step 907b. In a case that the model store executes steps 907a and 907b, steps 907a and 907b can be executed simultaneously, or step 907a can be executed first and then step 907b is executed, or step 907b can be executed first and then step 907a is executed, which is not limited in this application.

Optionally, the registration or publish result includes a model identifier, a version number corresponding to the model, and a model file.

Step 908: The UE sends at least one of the following information to the 3GPP network side:
(a) UE-supported model capability information, or (b) a UE vendor server identifier, where the UE vendor server identifier can be carried in the IMEI.

It should be noted that the UE may send the UE-supported model capability information and the version number corresponding to the model to the 3GPP network side such as the base station, via a radio capability of the RRC layer;
or
the UE may send the UE-supported model capability information and the version number corresponding to the model to the AMF via a 5G MM capability, and the AMF sends it to the 3GPP network side.

Step 909: The 3GPP network side performs model transmission, that is, the 3GPP network side sends the model identifier and model file to the UE.

Optionally, the model file includes a model file before the conversion by the UE vendor server or a model file obtained after the conversion by the UE vendor server.

Step 910: The 3GPP network side such as the access network device/core network device performs model activation management in a case of determining that the UE meets a trigger condition of the model and the UE supports a to-be-activated parameter.

That is, the 3GPP network side sends a message for activating the model to the UE, where the message carries at least one of the following information:
(a) a model identifier of the to-be-activated model; or (b) a to-be-activated parameter.

Step 911: The UE uses a to-be-activated parameter activation model.

For example, the UE executes the model based on a model identifier of the to-be-activated model and the to-be-activated parameter, and obtains a result.

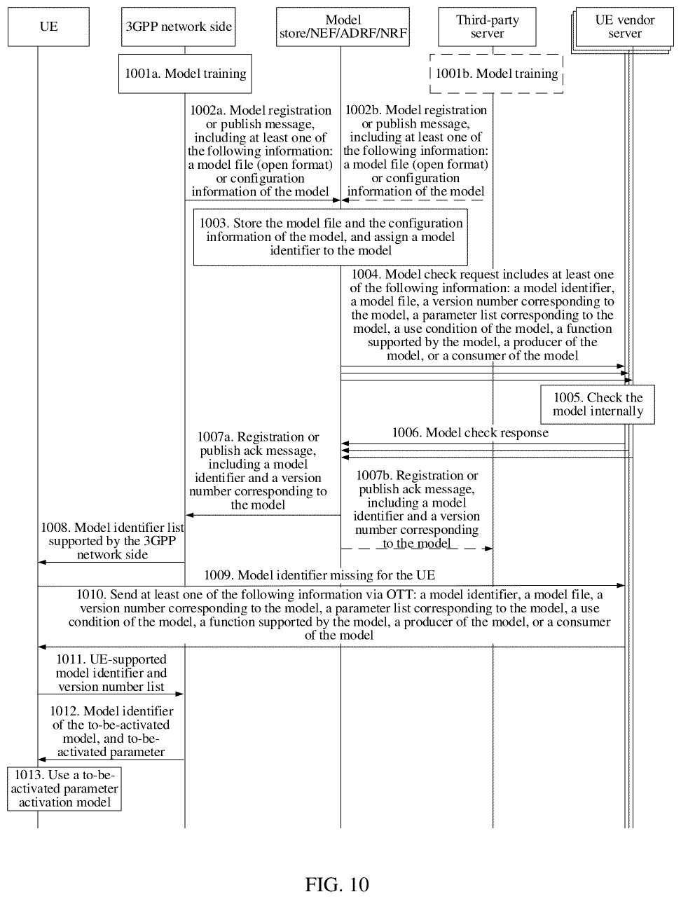

FIG. 10 is a fifth schematic diagram of signaling interaction of a model processing, registration and execution method according to an embodiment of this application. As shown in FIG. 10, it includes steps 1001 to 1013. Step 1001 includes steps 1001a and 1001b, step 1002 includes steps 1002a and 1002b, and step 1007 includes steps 1007a and 1007b. FIG. 10 shows another implementation scheme in which a UE vendor server sends a model file to UE.

Step 1001a: A 3GPP network side performs model training.

Step 1001b: A third-party server performs model training.

It should be noted that in practice, only step 1001a or step 1001b may be executed, which is not limited in this application. Optionally, the model may be an AI model, an ML model, or the like.

Step 1002a: The 3GPP network side sends a model registration or publish message to the model store, where the model registration or publish message is used to register or publish a trained model to the model store.

Step 1002b: The third-party server sends a model registration or publish message to the model store, where the model registration or publish message is used to register or publish a trained model to the model store.

It should be noted that step 1002a corresponds to step 1001a, and step 1002b corresponds to step 1001b, that is, in a case that the 3GPP network side executes step 1001a, the 3GPP network side executes step 1002a; while in a case that the third-party server executes step 1001b, the third-party server executes step 1002b.

Optionally, the model registration or publish message includes at least one of the following information:
a model file (open format) or configuration information of the model, where the configuration information of the model includes at least one of the following:
(a) a version number corresponding to the model, (b) a parameter list corresponding to the model, (c) a use condition of the model, (d) a function supported by the model, (e) a producer of the model, or (f) a consumer of the model.

Step 1003: The model store stores the model file and the configuration information of the model, and assigns a globally unique model identifier to the model.

Step 1004: The model store sends a model check request to each UE vendor server.

For example, the model check request includes at least one of the following information:
(a) a model identifier, (b) a model file, (c) a version number corresponding to the model, (d) a parameter list corresponding to the model, (e) a use condition of the model, (f) a function supported by the model, (g) a producer of the model, or (h) a consumer of the model.

Step 1005: Each UE vendor server checks the model internally.

It should be noted that checking the model refers to testing or correspondingly transforming parameters that can be used in the model.

Conversion means converting from a model mode not supported by the UE vendor (for example, an encoding format of the model file) to a model mode supported by the UE vendor.

Step 1006: Each UE vendor server sends a model check response to the model store, including a conversion result and a test result.

It should be noted that the test result includes a test success result and a test failure result.

Step 1007a: The model store sends a model registration or publish ack message to the 3GPP network side, including a registration or publish result.

Step 1007b: The model store sends a model registration or publish ack message to the third-party server, including a registration or publish result.

It should be noted that in practice, the model store can execute both steps 1007a and 1007b, or only step 1007a or only step 1007b. In a case that the model store executes steps 1007a and 1007b, steps 1007a and 1007b can be executed simultaneously, or step 1007a can be executed first and then step 1007b is executed, or step 1007b can be executed first and then step 1007a is executed, which is not limited in this application.

Optionally, the registration or publish result includes a model identifier and a version number corresponding to the model.

Step 1008: The 3GPP network side sends a model identifier list supported by the 3GPP network side to the UE.

For example, the 3GPP network side may send the supported model identifier list to the UE via a SIB; or the 3GPP network side may send the model identifier list supported by the 3GPP network side to the UE via an RRC message or a NAS message.

Step 1009: The UE compares its supported model identifier list with the model identifier list supported by the network side. If there is a model identifier missing for the UE, the UE proactively sends the missing model identifier to its associated UE vendor server to request downloading information such as a model file corresponding to the model identifier.

Step 1010: The UE vendor server sends the model identifier, the model file, the version number corresponding to the model, the parameter list corresponding to the model, the usable condition of the model, the function supported by the model, the producer of the model, and the consumer of the model to the UE through the application layer, such as the OTT (Over The Top).

Optionally, the model file includes a model file before the conversion by the UE vendor server or a model file obtained after the conversion by the UE vendor server.

The push manner includes: the UE periodically requests the UE vendor server to check for a new model file; when the UE vendor server has a new model file, it notifies the UE; then the UE retrieves the new model file from the UE vendor server based on the notification.

Step 1011: The UE sends a UE-supported model identifier and a version number list to the 3GPP network side.

For example, the UE may send, to the 3GPP network side such as a base station, the UE-supported model identifier and the version number list via a radio capability at the RRC layer;
or
the UE may send the UE-supported model identifier and the version number list to the AMF via a 5G MM capability, and then the AMF sends it to the 3GPP network side.

Step 1012: The 3GPP network side such as the access network device/core network device performs model activation management in a case of determining that the UE meets a trigger condition of the model and the UE supports a to-be-activated parameter.

That is, the 3GPP network side sends a message for activating the model to the UE, where the message carries at least one of the following information:
(a) a model identifier of the to-be-activated model; or (b) a to-be-activated parameter.

Step 1013: The UE uses a to-be-activated parameter activation model.

For example, the UE executes the model based on a model identifier of the to-be-activated model and the to-be-activated parameter, and obtains a result.

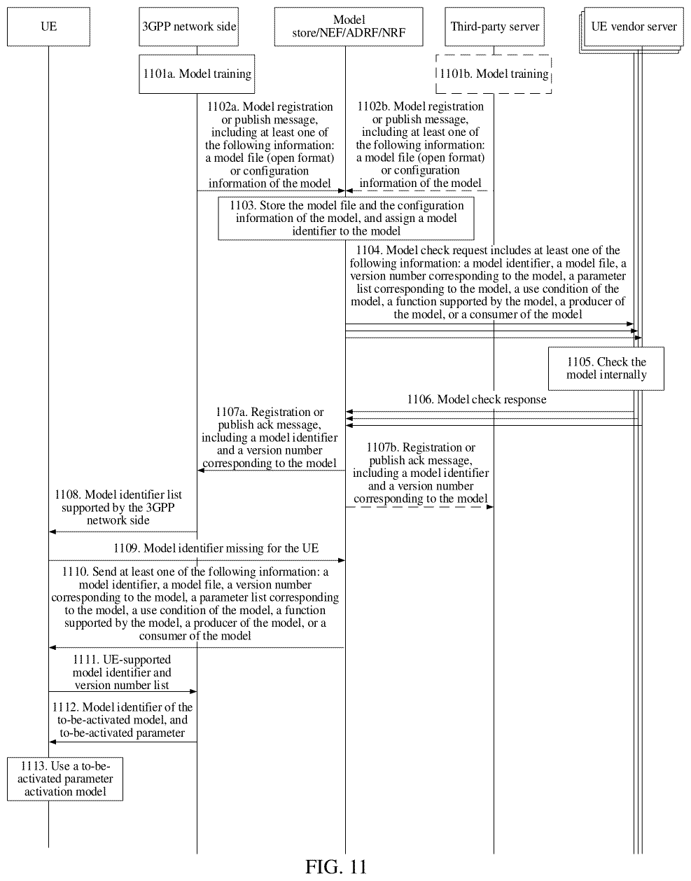

FIG. 11 is a sixth schematic diagram of signaling interaction of a model processing, registration and execution method according to an embodiment of this application. As shown in FIG. 11, it includes steps 1101 to 1113. Step 1101 includes steps 1101a and 1101b, step 1102 includes steps 1102a and 1102b, and step 1107 includes steps 1107a and 1107b. FIG. 11 shows another implementation scheme in which a model store sends a model file to UE.

Step 1101a: A 3GPP network side performs model training.

Step 1101b: A third-party server performs model training.

It should be noted that in practice, only step 1101a or step 1101b may be executed, which is not limited in this application. Optionally, the model may be an AI model, an ML model, or the like.

Step 1102a: The 3GPP network side sends a model registration or publish message to the model store, where the model registration or publish message is used to register or publish a trained model to the model store.

Step 1102b: The third-party server sends a model registration or publish message to the model store, where the model registration or publish message is used to register or publish a trained model to the model store.

It should be noted that step 1102a corresponds to step 1101a, and step 1102b corresponds to step 1101b, that is, in a case that the 3GPP network side executes step 1101a, the 3GPP network side executes step 1102a; while in a case that the third-party server executes step 1101b, the third-party server executes step 1102b.

Optionally, the model registration or publish message includes at least one of the following information:
a model file (open format) or configuration information of the model, where the configuration information of the model includes at least one of the following:
(a) a version number corresponding to the model, (b) a parameter list corresponding to the model, (c) a use condition of the model, (d) a function supported by the model, (e) a producer of the model, or (f) a consumer of the model.

Step 1103: The model store stores the model file and the configuration information of the model, and assigns a globally unique model identifier to the model.

Step 1104: The model store sends a model check request to each UE vendor server.

For example, the model check request includes at least one of the following information:
(a) a model identifier, (b) a model file, (c) a version number corresponding to the model, (d) a parameter list corresponding to the model, (e) a use condition of the model, (f) a function supported by the model, (g) a producer of the model, or (h) a consumer of the model.

Step 1105: Each UE vendor server checks the model internally.

It should be noted that checking the model refers to testing or correspondingly transforming parameters that can be used in the model.

Conversion means converting from a model mode not supported by the UE vendor (for example, an encoding format of the model file) to a model mode supported by the UE vendor.

Step 1106: Each UE vendor server sends a model check response to the model store, including a conversion result and a test result.

It should be noted that the test result includes a test success result and a test failure result.

Step 1107a: The model store sends a model registration or publish ack message to the 3GPP network side, including a registration or publish result.

Step 1107b: The model store sends a model registration or publish ack message to the third-party server, including a registration or publish result.

It should be noted that in practice, the model store can execute both steps 1107a and 1107b, or only step 1107a or only step 1107b. In a case that the model store executes steps 1107a and 1107b, steps 1107a and 1107b can be executed simultaneously, or step 1107a can be executed first and then step 1107b is executed, or step 1107b can be executed first and then step 1107a is executed, which is not limited in this application.

Optionally, the registration or publish result includes a model identifier and a version number corresponding to the model.

Step 1108: The 3GPP network side sends a model identifier list supported by the 3GPP network side to the UE.

For example, the 3GPP network side may send the supported model identifier list to the UE via a SIB; or the 3GPP network side may send the model identifier list supported by the 3GPP network side to the UE via an RRC message or a NAS message.

Step 1109: The UE compares its supported model identifier list with the model identifier list supported by the network side. If there is a model identifier missing for the UE, the UE sends at least one of the following information to the model store: UE-supported model capability information, or a version number corresponding to the model, where the version number corresponding to the model may be carried in the IMEI.

Step 1110: The model store sends the model identifier, the model file, the version number corresponding to the model, the parameter list corresponding to the model, the usable condition of the model, the function supported by the model, the producer of the model, and the consumer of the model to the UE.

Optionally, the model file includes a model file before the conversion by the UE vendor server or a model file obtained after the conversion by the UE vendor server.

For example, the model store may proactively push it to the UE, or the UE may periodically obtain it from the model store.

The UE periodically obtaining it from the model store can be implemented in the following manners: the UE periodically requests the model store to check for a new model file; when the model store has a new model file, it notifies the UE; then the UE retrieves the new model file from the model store based on the notification.

Step 1111: The UE sends a UE-supported model identifier and a version number list to the 3GPP network side.

For example, the UE may send, to the 3GPP network side such as a base station, the UE-supported model identifier and the version number list via a radio capability at the RRC layer;

or the UE may send the UE-supported model identifier and the version number list to the AMF via a 5G MM capability, and then the AMF sends it to the 3GPP network side.

Step 1112: The 3GPP network side such as the access network device/core network device performs model activation management in a case of determining that the UE meets a trigger condition of the model and the UE supports a to-be-activated parameter.

That is, the 3GPP network side sends a message for activating the model to the UE, where the message carries at least one of the following information:
(a) a model identifier of the to-be-activated model; or (b) a to-be-activated parameter.

Step 1113: The UE uses a to-be-activated parameter activation model.

For example, the UE executes the model based on a model identifier of the to-be-activated model and the to-be-activated parameter, and obtains a result.

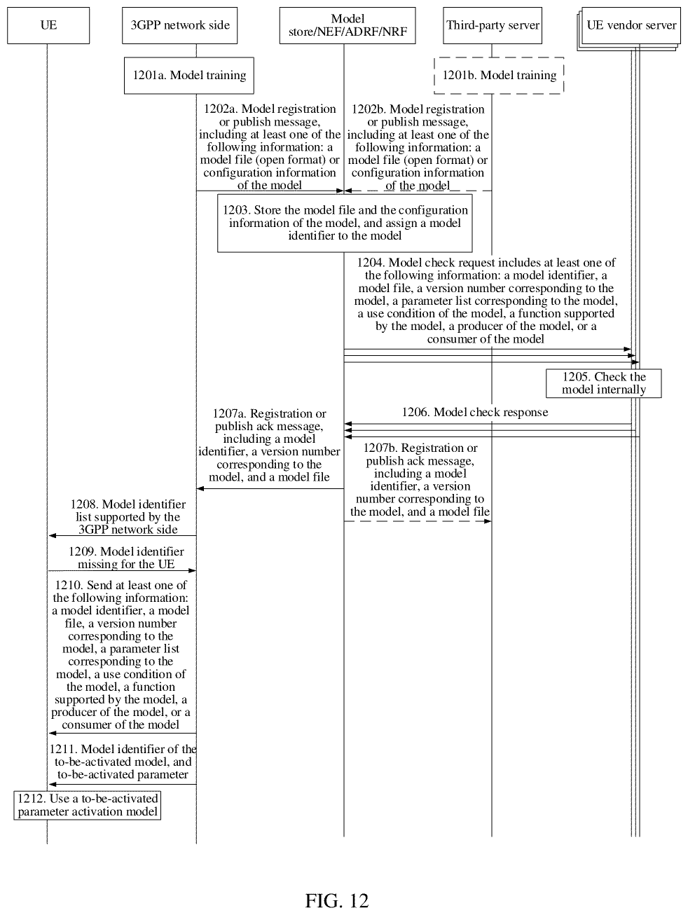

FIG. 12 is a seventh schematic diagram of signaling interaction of a model processing, registration and execution method according to an embodiment of this application. As shown in FIG. 12, it includes steps 1201 to 1212. Step 1201 includes steps 1201a and 1201b, step 1202 includes steps 1202a and 1202b, and step 1207 includes steps 1207a and 1207b. FIG. 12 shows another implementation scheme in which a 3GPP network side sends a model file to UE.

Step 1201a: A 3GPP network side performs model training.

Step 1201b: A third-party server performs model training.

It should be noted that in practice, only step 1201a or step 1201b may be executed, which is not limited in this application. Optionally, the model may be an AI model, an ML model, or the like.

Step 1202a: The 3GPP network side sends a model registration or publish message to the model store, where the model registration or publish message is used to register or publish a trained model to the model store.

Step 1202b: The third-party server sends a model registration or publish message to the model store, where the model registration or publish message is used to register or publish a trained model to the model store.

It should be noted that step 1202a corresponds to step 1201a, and step 1202b corresponds to step 1201b, that is, in a case that the 3GPP network side executes step 1201a, the 3GPP network side executes step 1202a; while in a case that the third-party server executes step 1201b, the third-party server executes step 1202b.

Optionally, the model registration or publish message includes at least one of the following information:
a model file (open format) or configuration information of the model, where the configuration information of the model includes at least one of the following:
(a) a version number corresponding to the model, (b) a parameter list corresponding to the model, (c) a use condition of the model, (d) a function supported by the model, (e) a producer of the model, or (f) a consumer of the model.

Step 1203: The model store stores the model file and the configuration information of the model, and assigns a globally unique model identifier to the model.

Step 1204: The model store sends a model check request to each UE vendor server.

For example, the model check request includes at least one of the following information:
(a) a model identifier, (b) a model file, (c) a version number corresponding to the model, (d) a parameter list corresponding to the model, (e) a use condition of the model, (f) a function supported by the model, (g) a producer of the model, or (h) a consumer of the model.

Step 1205: Each UE vendor server checks the model internally.

It should be noted that checking the model refers to testing or correspondingly transforming parameters that can be used in the model.

Conversion means converting from a model mode not supported by the UE vendor (for example, an encoding format of the model file) to a model mode supported by the UE vendor.

Step 1206: Each UE vendor server sends a model check response to the model store, including a conversion result and a test result.

It should be noted that the test result includes a test success result and a test failure result.

Step 1207a: The model store sends a model registration or publish ack message to the 3GPP network side, including a registration or publish result.

Step 1207b: The model store sends a model registration or publish ack message to the third-party server, including a registration or publish result.

It should be noted that in practice, the model store can execute both steps 1207a and 1207b, or only step 1207a or only step 1207b. In a case that the model store executes steps 1207a and 1207b, steps 1207a and 1207b can be executed simultaneously, or step 1207a can be executed first and then step 1207b is executed, or step 1207b can be executed first and then step 1207a is executed, which is not limited in this application.

In steps 1207a and 1207b, the registration or publish result includes a model identifier, a version number corresponding to the model, and a model file.

Step 1208: The 3GPP network side sends a model identifier list supported by the 3GPP network side to the UE.

For example, the 3GPP network side may send the supported model identifier list to the UE via a SIB; or the 3GPP network side may send the model identifier list supported by the 3GPP network side to the UE via an RRC message or a NAS message.

Step 1209: The UE compares its supported model identifier list with the model identifier list supported by the network side. If there is a model identifier missing for the UE, the UE sends at least one of the following information to the 3GPP network side:
(a) UE-supported model capability information, or (b) a version number corresponding to the model, where the version number corresponding to the model may be carried in the IMEI.

It should be noted that the UE may send the UE-supported model capability information and the version number corresponding to the model to the 3GPP network side such as the base station, via a radio capability of the RRC layer;
or
the UE may send the UE-supported model capability information and the version number corresponding to the model to the AMF via a 5G MM capability, and the AMF sends it to the 3GPP network side.

Step 1210: The 3GPP network side performs model transmission, that is, the 3GPP network side sends the model identifier and model file to the UE.

Optionally, the model file includes a model file before the conversion by the UE vendor server or a model file obtained after the conversion by the UE vendor server.

Step 1211: The 3GPP network side such as the access network device/core network device performs model activation management in a case of determining that the UE meets a trigger condition of the model and the UE supports a to-be-activated parameter.

That is, the 3GPP network side sends a message for activating the model to the UE, where the message carries at least one of the following information:
(a) a model identifier of the to-be-activated model; or (b) a to-be-activated parameter.

Step 1212: The UE uses a to-be-activated parameter activation model.

For example, the UE executes the model based on a model identifier of the to-be-activated model and the to-be-activated parameter, and obtains a result.

In the model processing method provided in this embodiment of this application, the executing subject can be a model processing apparatus. In the embodiments of this application, the model processing apparatus provided in the embodiments of this application is described by using the model processing method being executed by the model processing apparatus as an example.

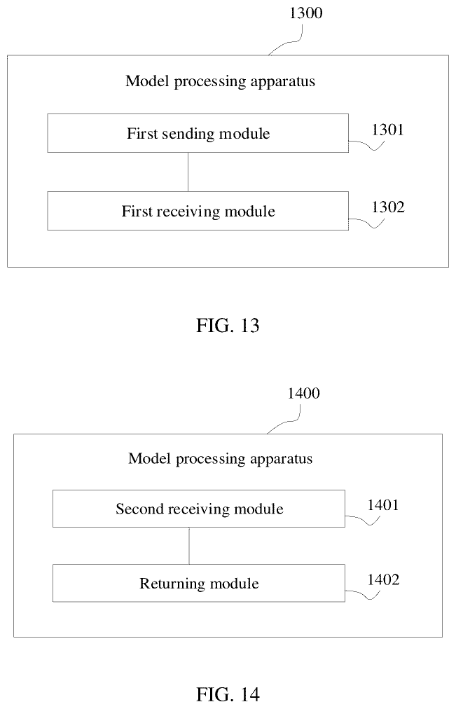

FIG. 13 is a first schematic structural diagram of a model processing apparatus according to an embodiment of this application. As shown in FIG. 13, the model processing apparatus 1300 is applied to a first device, and includes:
a first sending module 1301, configured to send a first message to at least one second device, where the first message includes a first model file corresponding to a first model; and
a first receiving module 1302, configured to receive a second message returned by the second device; where
the second message includes at least one of the following:
processing result information used for indicating a result obtained by processing the first model file; or
a second model file, where the second model file is obtained by converting the first model file.

The model processing apparatus provided in this embodiment of this application sends a first message to at least one second device, where the first message includes a first model file corresponding to a first model; and then receives a second message returned by the second device, where the second message includes at least one of processing result information or a second model file, the processing result information is used for indicating a result obtained by processing the first model file, and the second model file is obtained by converting the first model file. Based on the processing result information, it can be learned whether the first model file can be correctly executed in the second device and a terminal associated with the second device. Based on that the second message includes the second model file, it can be determined that the second model file can be correctly executed in the second device and the terminal associated with the second device. Therefore, based on the received processing result information or the second model file, it can be determined that whether the first model can be correctly executed in the terminal associated with the second device, so as to avoid a problem that the terminal cannot properly use the model.

Optionally, the apparatus further includes:
an assigning module, configured to assign a first identifier to the first model, where the first identifier is used to identify the first model.

Optionally, the first message further includes the first identifier.

Optionally, the first message further includes first information, where the first information includes at least one of the following:
information for indicating a version number of the first model;
information for indicating at least one parameter corresponding to the first model;
information for indicating a use condition or a use scenario of the first model;
information for indicating at least one function supported by the first model;
information for indicating a generating device or a training device of the first model;
or information for indicating a using device of the first model.

Optionally, the apparatus further includes:
a fourth receiving module, configured to receive a third message sent by a third device, where the third message includes the first model file, and the third message is used for registering the first model.

Optionally, the apparatus further includes:
a third sending module, configured to send a fourth message to the third device; where
the fourth message includes at least one of the following:
the processing result information; or
the second model file.

Optionally, the fourth message further includes at least one of the following:
a first identifier for identifying the first model;
the first model file;
first information, where the first information includes at least one of the following: information for indicating the version number of the first model; information for indicating at least one parameter corresponding to the first model; information for indicating a use condition or a use scenario of the first model; information for indicating at least one function supported by the first model; information for indicating a generating device or a training device of the first model; or information for indicating a using device of the first model; or
first indication information for indicating information about a manufacturer corresponding to the second device.

Optionally, the apparatus further includes:
a fourth sending module, configured to send a fifth message to a first terminal, where the fifth message includes the first model file or the second model file.

Optionally, the fifth message further includes at least one of the following: a first identifier for identifying the first model; or
first information, where the first information includes at least one of the following: information for indicating the version number of the first model; information for indicating at least one parameter corresponding to the first model; information for indicating a use condition or a use scenario of the first model; information for indicating at least one function supported by the first model; information for indicating a generating device or a training device of the first model; or information for indicating a using device of the first model.

Optionally, the fourth sending module is configured to perform at least one of the following:
sending the fifth message to the first terminal in a case that the first terminal has registered with the first device;
sending a sixth message to the first terminal in a case that a first request is received from the first terminal, where the first request is used to query whether there is an undownloaded or updated model file, and the sixth message is used for indicating that there is an undownloaded or updated model file in the first device; and sending the fifth message to the first terminal in a case that a second request is received from the first terminal, where the second request is used for obtaining the fifth message; or
sending the fifth message to the first terminal in a case that a seventh message is received from the first terminal, where the seventh message includes at least one of the following: a first identifier for identifying the first model; information for indicating a version number of the first model; or second indication information for indicating information about a manufacturer or terminal model corresponding to the first terminal.

Optionally, the first request includes second indication information.

Optionally, the second indication information is carried in an international mobile station equipment identity IMEI of the first terminal.

Optionally, the second model file can be correctly executed on the first terminal associated with the second device.

Optionally, the first device includes at least one of the following: a model store; a network exposure function NEF; an analytic data repository function ADRF; or a network repository function NRF.

Optionally, the third device includes at least one of the following: a core network device; an access network device; a target server device; or a second terminal.

FIG. 14 is a second schematic structural diagram of a model processing apparatus according to an embodiment of this application. As shown in FIG. 14, the model processing apparatus 1400 is applied to a second device, and includes:
a second receiving module 1401, configured to receive a first message sent by a first device, where the first message includes a first model file corresponding to a first model; and
a returning module 1402, configured to return a second message to the first device; where
the second message includes at least one of the following:
processing result information used for indicating a result obtained by processing the first model file; or
a second model file, where the second model file is obtained by converting the first model file.

The model processing apparatus provided in this embodiment of this application receives a first message sent by the first device, where the first message includes a first model file corresponding to a first model; and then returns a second message to the first device, where the second message includes at least one of processing result information or a second model file, the processing result information is used for indicating a result obtained by processing the first model file, and the second model file is obtained by converting the first model file. Based on the processing result information, the first device can learn whether the first model file can be correctly executed in the second device and a terminal associated with the second device. Based on that the second message includes the second model file, the first device can determine that the second model file can be correctly executed in the second device and the terminal associated with the second device. Therefore, returning the processing result information or the second model file to the first device can enable the first device to determine whether the first model can be correctly executed in the terminal associated with the second device, so as to avoid a problem that the terminal cannot properly use the model.

Optionally, the first message further includes a first identifier, and the first identifier is assigned to the first model by the first device and the first identifier is used for identifying the first model.

Optionally, the first message further includes first information, where the first information includes at least one of the following:
information for indicating a version number of the first model;
information for indicating at least one parameter corresponding to the first model;
information for indicating a use condition or a use scenario of the first model;
information for indicating at least one function supported by the first model;
information for indicating a generating device or a training device of the first model; or
information for indicating a using device of the first model.

Optionally, the apparatus further includes:
a fifth sending module, configured to send a fifth message to a first terminal, where the fifth message includes the first model file or the second model file.

Optionally, the fifth message further includes at least one of the following: a first identifier for identifying the first model; first information, where the first information includes at least one of the following: information for indicating the version number of the first model; information for indicating at least one parameter corresponding to the first model; information for indicating a use condition or a use scenario of the first model; information for indicating at least one function supported by the first model; information for indicating a generating device or a training device of the first model; or information for indicating a using device of the first model.

Optionally, the fifth sending module is configured to perform at least one of the following:
sending the fifth message to the first terminal in a case that the first terminal has registered with the second device;
sending an eighth message to the first terminal in a case that a third request is received from the first terminal, where the third request is used to query whether there is an undownloaded or updated model file, and the eighth message is used for indicating that there is an undownloaded or updated model file in the second device; and sending the fifth message to the first terminal in a case that a fourth request is received from the first terminal, where the fourth request is used for obtaining the fifth message; or
sending the fifth message to the first terminal in a case that a ninth message is received from the first terminal, where the ninth message includes at least one of the following: a first identifier for identifying the first model; information for indicating a version number of the first model; or second indication information for indicating information about a manufacturer or terminal model corresponding to the first terminal.

Optionally, the third request includes second indication information.

Optionally, the second indication information is carried in an international mobile station equipment identity IMEI of the first terminal.

Optionally, the second model file can be correctly executed on the first terminal associated with the second device.

Optionally, the first device includes at least one of the following: a model store; a network exposure function NEF; an analytic data repository function ADRF; or a network repository function NRF.

In the model execution method provided in this embodiment of this application, the executing subject can be a model execution apparatus. In the embodiments of this application, the model execution apparatus provided in the embodiments of this application is described by using the model execution method being executed by the model execution apparatus as an example.

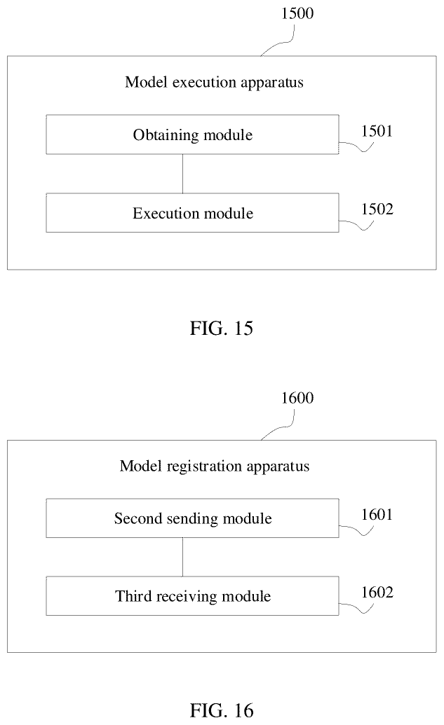

FIG. 15 is a schematic structural diagram of a model execution apparatus according to an embodiment of this application. As shown in FIG. 15, the model execution apparatus 1500 is applied to a first terminal, and includes:
an obtaining module 1501, configured to obtain a fifth message, where the fifth message includes a first model file corresponding to a first model or a second model file, and the second model file is obtained by converting the first model file; and
an execution module 1502, configured to execute the first model file or the second model file.

The model execution apparatus provided in this embodiment of this application obtains a fifth message, where the fifth message includes a first model file or a second model file corresponding to the first model, and the second model file is obtained by converting the first model file. Through execution of the first model file or the second model file, it can be ensured that the first model file or the second model file can be correctly executed on the first terminal, so as to avoid a problem that the first terminal cannot properly use the model.

Optionally, the fifth message further includes at least one of the following:
a first identifier for identifying the first model; or
first information, where the first information includes at least one of the following:
information for indicating a version number of the first model;
information for indicating at least one parameter corresponding to the first model;
information for indicating a use condition or a use scenario of the first model;
information for indicating at least one function supported by the first model;
information for indicating a generating device or a training device of the first model; or
information for indicating a using device of the first model.

Optionally, the obtaining module 1501 is configured to perform at least one of the following:
receiving the fifth message from a first device; or
sending a first request to the first device; receiving a sixth message from the first device, where the first request is used to query whether there is an undownloaded or updated model file, and the sixth message is used to indicate that there is an undownloaded or updated model file in the first device; sending a second request to the first device, where the second request is used for obtaining the fifth message; and receiving the fifth message from the first device.

Optionally, the first request includes second indication information for indicating information about a manufacturer or terminal model corresponding to the first terminal.

Optionally, the obtaining module 1501 is configured to perform at least one of the following:
receiving the fifth message from a second device; or
sending a third request to the second device; receiving an eighth message from the second device, where the third request is used to query whether there is an undownloaded or updated model file, and the eighth message is used to indicate that there is an undownloaded or updated model file in the second device; sending a fourth request to the second device, where the fourth request is used for obtaining the fifth message; and receiving the fifth message from the second device.

Optionally, the third request includes second indication information.

Optionally, the obtaining module 1501 is configured to perform at least one of the following:
receiving the fifth message from a third device; or
sending a fifth request to the third device; receiving a tenth message from the third device, where the fifth request is used to query whether there is an undownloaded or updated model file in the third device, and the tenth message is used to indicate that there is an undownloaded or updated model file in the third device; sending a sixth request to the third device, where the sixth request is used for obtaining the fifth message; and receiving the fifth message from the third device.

Optionally, the fifth request includes second indication information.

Optionally, the obtaining module 1501 is configured to:
sending an eleventh message to a third device; and
receiving the fifth message from the third device; where
the eleventh message includes at least one of the following:
second indication information for indicating information about a manufacturer or terminal model corresponding to the first terminal; or
a first model list, including an identifier of at least one model supported by the first terminal or at least one version number.

Optionally, the eleventh message is carried by at least one of the following messages: a radio resource control RRC message; or a non-access stratum NAS message.

Optionally, the obtaining module 1501 is configured to:
receiving a twelfth message from a third device, where the twelfth message is used to indicate a second model list, and the second model list includes at least one of the following: an identifier of at least one model supported by the third device or at least one version number; and
obtaining the fifth message based on the first model list and the second model list in a case that it is determined that a first identifier or information indicating a version number of the first model is present in the second model list but not in the first model list, where the first identifier is used for identifying the first model.

Optionally, the obtaining module 1501 is configured to perform at least one of the following:
sending a seventh message to the first device based on the first identifier or the information for indicating the version number of the first model, where the seventh message includes at least one of the first identifier, the information for indicating the version number of the first model, or second indication information, and the second indication information is used for indicating information about a manufacturer or terminal model corresponding to the first terminal; and receiving the fifth message from the first device;
sending a ninth message to a second device based on the first identifier or the information for indicating the version number of the first model, where the ninth message includes at least one of the first identifier, the information for indicating the version number of the first model, or second indication information, and the second indication information is used for indicating information about a manufacturer or terminal model corresponding to the first terminal; and receiving the fifth message from the second device; or
sending a thirteenth message to a third device based on the first identifier or the information for indicating the version number of the first model, where the thirteenth message includes at least one of the first identifier, the information for indicating the version number of the first model, or second indication information, and the second indication information is used for indicating information about a manufacturer or terminal model corresponding to the first terminal; and receiving the fifth message from the third device.

Optionally, the second indication information is carried in an international mobile station equipment identity IMEI of the first terminal.

Optionally, the twelfth message is carried by at least one of the following messages: a system information block SIB message; a radio resource control RRC message; or a non-access stratum NAS message.

Optionally, the apparatus further includes:
a fifth receiving module, configured to receive a fourteenth message from the third device; and
an activation module, configured to activate the first model based on the fourteenth message.

Optionally, the fourteenth message includes at least one of the following:
a first identifier for identifying the first model;
information for indicating a version number of the first model; or
at least one to-be-activated parameter.

Optionally, the apparatus further includes:
a sixth sending module, configured to send a fifteenth message to the third device, where the fifteenth message is configured to indicate a first model list.

Optionally, the fifteenth message is carried by at least one of the following messages:
an RRC message; or a NAS message.

Optionally, the second model file can be correctly executed on the first terminal associated with the second device.

Optionally, the first device includes at least one of the following: a model store; a network exposure function NEF; an analytics data repository function ADRF; or a network repository function NRF.

Optionally, the third device includes at least one of the following: a core network device; an access network device; a target server device; or a second terminal.

In the model registration method provided in this embodiment of this application, the executing subject can be a model registration apparatus. In the embodiments of this application, the model registration apparatus provided in the embodiments of this application is described by using the model registration method being executed by the model registration apparatus as an example.

FIG. 16 is a schematic structural diagram of a model registration apparatus according to an embodiment of this application. As shown in FIG. 16, the model registration apparatus 1600 is applied to a third device, and includes:
a second sending module 1601, configured to send a third message to a first device, where the third message includes a first model file corresponding to a first model, and the third message is used for registering the first model; and
a third receiving module 1602, configured to receive a fourth message returned by the first device; where
the fourth message includes at least one of the following:
processing result information used for indicating a result obtained by processing the first model file; or
a second model file, where the second model file is obtained by converting the first model file.

The model registration apparatus provided in this embodiment of this application sends a third message to the first device, so that the first device registers the first model based on the first model file corresponding to the first model included in the third message; and then receives processing result information and a second model file that are returned by the first device, where the processing result information is used for indicating a result obtained by processing the first model file, and the second model file is obtained by converting the first model file. Based on the processing result information, it can be learned whether the first model file can be correctly executed in the second device and a terminal associated with the second device. Based on that the second message includes the second model file, it can be determined that the second model file can be correctly executed in the second device and the terminal associated with the second device. Therefore, based on the processing result information or the second model file, it can be determined whether the first model can be correctly executed in the terminal associated with the second device, so as to avoid a problem that the terminal cannot properly use the model.

Optionally, the third message further includes first information, where the first information includes at least one of the following:
information for indicating a version number of the first model;
information for indicating at least one parameter corresponding to the first model;
information for indicating a use condition or a use scenario of the first model;
information for indicating at least one function supported by the first model;
information for indicating a generating device or a training device of the first model; or
information for indicating a using device of the first model.

Optionally, the fourth message further includes at least one of the following: a first identifier for identifying the first model; a first model file; first indication information for indicating information about a manufacturer corresponding to a second device; or first information, where the first information includes at least one of the following: information for indicating the version number of the first model; information for indicating at least one parameter corresponding to the first model; information for indicating a use condition or a use scenario of the first model; information for indicating at least one function supported by the first model; information for indicating a generating device or a training device of the first model; or information for indicating a using device of the first model.

Optionally, the apparatus further includes:
a seventh sending module, configured to send a fifth message to a first terminal, where the fifth message includes the first model file or the second model file.

Optionally, the fifth message further includes at least one of the following: a first identifier for identifying the first model; first information, where the first information includes at least one of the following: information for indicating the version number of the first model; information for indicating at least one parameter corresponding to the first model; information for indicating a use condition or a use scenario of the first model; information for indicating at least one function supported by the first model; information for indicating a generating device or a training device of the first model; or information for indicating a using device of the first model.

Optionally, the seventh sending module is configured to perform at least one of the following:
sending the fifth message to the first terminal in a case that the first terminal has registered with the third device; or
sending a tenth message to the first terminal in a case that a fifth request is received from the first terminal, where the fifth request is used to query whether there is an undownloaded or updated model file in the third device, and the tenth message is used for indicating that there is an undownloaded or updated model file in the third device; and sending the fifth message to the first terminal in a case that a sixth request is received from the first terminal, where the sixth request is used for obtaining the fifth message.

Optionally, the fifth request includes second indication information for indicating information about a manufacturer or terminal model corresponding to the first terminal.

Optionally, the seventh sending module is configured to:
receive an eleventh message from the first terminal; and send a fifth message to the first terminal based on the eleventh message; where
the eleventh message includes at least one of the following:
second indication information for indicating information about a manufacturer or terminal model corresponding to the first terminal; or
a first model list, including an identifier of at least one model supported by the first terminal or at least one version number.

Optionally, the eleventh message is carried by at least one of the following messages: a radio resource control RRC message; or a non-access stratum NAS message.

Optionally, the seventh sending module is configured to:
receive a thirteenth message from the first terminal; and
send the fifth message to the first terminal based on the thirteenth message; where the thirteenth message includes at least one of the following: a first identifier for identifying the first model, information for indicating a version number of the first model, or second indication information, and the second indication information is used for indicating information about a manufacturer or terminal model corresponding to the first terminal.

Optionally, the second indication information is carried in an international mobile station equipment identity IMEI.

Optionally, the apparatus further includes:
an eighth sending module, configured to send a twelfth message to the first terminal, where the twelfth message is used to indicate a second model list, and the second model list includes at least one of the following: an identifier of at least one model supported by the third device or at least one version number.

Optionally, the twelfth message is carried by at least one of the following messages: a system information block SIB message; a radio resource control RRC message; or a non-access stratum NAS message.

Optionally, the apparatus further includes:
a ninth sending module, configured to send a fourteenth message to the first terminal in a case that the first terminal meets a trigger condition of the first model and the first terminal supports at least one to-be-activated parameter, where the fourteenth message is used for indicating to activate the first model.

Optionally, the fourteenth message includes at least one of the following:
a first identifier for identifying the first model;
information for indicating a version number of the first model; or
at least one to-be-activated parameter.

Optionally, the apparatus further includes:
a sixth receiving module, configured to receive a fifteenth message from the first terminal, where the fifteenth message is used to indicate a first model list.

Optionally, the fifteenth message is carried by at least one of the following messages: an RRC message; or a NAS message.

Optionally, the second model file can be correctly executed on the first terminal associated with the second device.

Optionally, the first device includes at least one of the following: a model store; a network exposure function NEF; an analytics data repository function ADRF; or a network repository function NRF.

Optionally, the third device includes at least one of the following: a core network device; an access network device; a target server device; or a second terminal.

The model processing apparatus, the model execution apparatus, and the model registration apparatus in the embodiments of this application may be an electronic device, such as an electronic device with an operating system, or a component in the electronic device, such as an integrated circuit or a chip. The electronic device may be a terminal or a device other than terminals. For example, the terminal may include, but is not limited to, the types of the terminal 11 listed above, and other devices may be a server, a network attached storage (NAS), and the like. This is not limited in the embodiments of this application.

The model processing apparatus provided in the embodiments of this application can implement the processes implemented in the method embodiments of FIG. 2 and FIG. 3, with the same technical effects achieved. The model execution apparatus provided in the embodiments of this application can implement the processes implemented in the method embodiment of FIG. 4, with the same technical effects achieved. The model registration apparatus provided in the embodiments of this application can implement the processes implemented in the method embodiment of FIG. 5, with the same technical effects achieved. To avoid repetition, details are not described herein again.

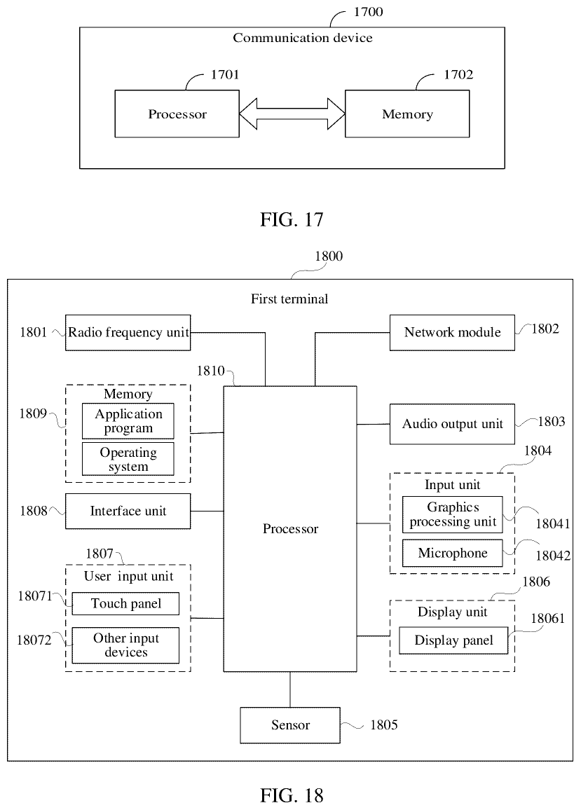

FIG. 17 is a schematic structural diagram of a communication device according to an embodiment of this application. As shown in FIG. 17, an embodiment of this application further provides a communication device 1700, including a processor 1701 and a memory 1702. A program or instructions executable on the processor 1701 are stored in the memory 1702. For example, when the communication device 1700 is a first device and when the program or the instructions are executed by the processor 1701, the steps of the foregoing embodiments of the model processing method shown in FIG. 2 are implemented, with the same technical effects achieved. When the communication device 1700 is a second device, and the program or instructions are executed by the processor 1701, the steps of the foregoing embodiments of the model processing method shown in FIG. 3 are implemented, with the same technical effects achieved. When the communication device 1700 is a first terminal, and the program or instructions are executed by the processor 1701, the steps of the foregoing embodiments of the model execution method shown in FIG. 4 are implemented, with the same technical effects achieved. When the communication device 1700 is a third device, and the program or instructions are executed by the processor 1701, the steps of the foregoing embodiments of the model registration method shown in FIG. 5 are implemented, with the same technical effects achieved. To avoid repetition, details are not described herein again.

An embodiment of this application further provides a first terminal, which includes a processor and a communication interface, where the communication interface is coupled to the processor, and the processor is configured to run a program or instructions to implement the steps of the model execution method embodiments shown in FIG. 4. The first terminal embodiment corresponds to the foregoing first terminal side method embodiment, and the implementation processes and implementations of the foregoing method embodiments can be applied to the first terminal embodiments, with the same technical effects achieved. Optionally, FIG. 18 is a schematic structural diagram of a first terminal according to an embodiment of this application.

The first terminal 1800 includes but is not limited to at least part of components such as a radio frequency unit 1801, a network module 1802, an audio output unit 1803, an input unit 1804, a sensor 1805, a display unit 1806, a user input unit 1807, an interface unit 1808, a memory 1809, and a processor 1810.

Persons skilled in the art can understand that the first terminal 1800 may further include a power supply (for example, a battery) supplying power to the components, and the power supply may be logically connected to the processor 1810 through a power management system. In this way, functions such as charge management, discharge management, and power consumption management are implemented by using the power management system. The structure of the first terminal shown in FIG. 18 does not constitute any limitation on the first terminal. The first terminal may include more or fewer components than shown in the figure, or a combination of some components, or the components disposed differently. Details are not described herein again.

It can be understood that in this embodiment of this application, the input unit 1804 may include a graphics processing unit (GPU) 18041 and a microphone 18042. The graphics processing unit 18041 processes image data of a still picture or video obtained by an image capture apparatus (such as a camera) in a video capture mode or an image capture mode. The display unit 1806 may include a display panel 18061, and the display panel 18061 may be configured in a form of a liquid crystal display, an organic light-emitting diode, and the like. The user input unit 1807 includes at least one of a touch panel 18071 or other input devices 18072. The touch panel 18071 is also referred to as a touchscreen. The touch panel 18071 may include two parts: a touch detection apparatus and a touch controller. The other input devices 18072 may include but be not limited to a physical keyboard, a function key (such as a volume control key or an on/off key), a trackball, a mouse, and a joystick. Details are not described herein.

In this embodiment of this application, after receiving downlink data from a network-side device, the radio frequency unit 1801 sends the downlink data to the processor 1810 for processing; and the radio frequency unit 1801 also sends uplink data to the network-side device. Generally, the radio frequency unit 1801 includes but is not limited to an antenna, an amplifier, a transceiver, a coupler, a low noise amplifier, a duplexer, and the like.

The memory 1809 may be configured to store software programs or instructions and various data. The memory 1809 may mainly include a first storage area for storing programs or instructions and a second storage area for storing data, where the first storage area may store an operating system, an application program or instructions required by at least one function (for example, an audio playing function and an image playing function), and the like. For example, the memory 1809 may include a volatile memory or a nonvolatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), synchronous dynamic random access memory (SDRAM), a double data rate synchronous dynamic random access memory (DDRSDRAM), an enhanced synchronous dynamic random access memory (ESDRAM), a synchronous link dynamic random access memory (SLDRAM), and a direct memory bus random access memory (DRRAM). The memory 1809 described in this embodiment this application includes but is not limited to these and any other appropriate types of memories.

The processor 1810 may include one or more processing units. Optionally, the processor 1810 may integrate an application processor and a modem processor. The application processor primarily processes operations involving an operating system, user interface, application program, or the like. The modem processor primarily processes radio communication signals, for example, being a baseband processor. It can be understood that the modem processor may alternatively be not integrated in the processor 1810.

It can be understood that for the implementation processes of the implementations mentioned in this embodiment of this application, reference may be made to the related descriptions of the embodiments of the model execution method shown in FIG. 4, with the same or corresponding technical effects achieved. To avoid repetition, details are not described herein again.

An embodiment of this application further provides a first device, which includes a processor and a communication interface, where the communication interface is coupled to the processor, and the processor is configured to run a program or instructions to implement the steps of the model processing method embodiments shown in FIG. 2. The first device embodiments correspond to the foregoing first device method embodiments, and the implementation processes and implementations of the foregoing method embodiments can be applied to the first device embodiments, with the same technical effects achieved.

An embodiment of this application further provides a second device, which includes a processor and a communication interface, where the communication interface is coupled to the processor, and the processor is configured to run a program or instructions to implement the steps of the model processing method embodiments shown in FIG. 3. The second device embodiments correspond to the foregoing second device method embodiments, and the implementation processes and implementations of the foregoing method embodiments can be applied to the second device embodiments, with the same technical effects achieved.

An embodiment of this application further provides a third device, which includes a processor and a communication interface, where the communication interface is coupled to the processor, and the processor is configured to run a program or instructions to implement the steps of the model processing method embodiments shown in FIG. 5. The third device embodiments correspond to the foregoing third device method embodiments, and the implementation processes and implementations of the foregoing method embodiments can be applied to the third device embodiments, with the same technical effects achieved.

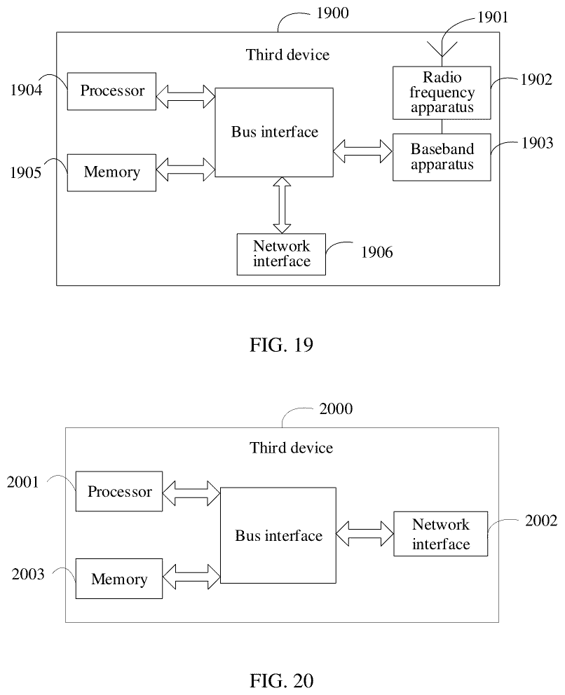

FIG. 19 is a first schematic structural diagram of a third device according to an embodiment of this application. As shown in FIG. 19, the third device 1900 includes an antenna 1901, a radio frequency apparatus 1902, a baseband apparatus 1903, a processor 1904, and memory 1905. The antenna 1901 is connected to the radio frequency apparatus 1902. In an uplink direction, the radio frequency apparatus 1902 receives information by using the antenna 1901, and sends the received information to the baseband apparatus 1903 for processing. In a downlink direction, the baseband apparatus 1903 processes to-be-sent information, and sends the information to the radio frequency apparatus 1902; and the radio frequency apparatus 1902 processes the received information and then sends the information out by using the antenna 1901.

The method executed by the third device in the foregoing embodiments may be implemented on the baseband apparatus 1903. The baseband apparatus 1903 includes a baseband processor.

The baseband apparatus 1903 may include, for example, at least one baseband board, where a plurality of chips are disposed on the baseband board. As shown in FIG. 19, one of the chips is, for example, the baseband processor, and connected to the memory 1905 through a bus interface, to invoke the program in the memory 1905 to perform the operations of the network device shown in the foregoing method embodiment.

The third device may further include a network interface 1906, where the interface is, for example, a common public radio interface (CPRI).

Optionally, the third device 1900 in this embodiment of the present application further includes a program or instructions stored in the memory 1905 and executable on the processor 1904. When the processor 1904 invokes the program or instructions in the memory 1905, the methods shown in FIG. 2, FIG. 3, and FIG. 5 are performed, with the same technical effects achieved. To avoid repetition, details are not described herein again.

FIG. 20 is a second schematic structural diagram of a third device according to an embodiment of this application. As shown in FIG. 20, the third device 2000 includes a processor 2001, a network interface 2002 and a memory 2003. The network interface 2002 is, for example, a common public radio interface (CPRI).

Optionally, the third device 2000 in this embodiment of the present application further includes a program or instructions stored in the memory 2003 and executable on the processor 2001. When the processor 2001 invokes the program or instructions in the memory 2003, the methods shown in FIG. 2, FIG. 3, and FIG. 5 are performed, with the same technical effects achieved. To avoid repetition, details are not described herein again.

An embodiment of this application further provides a non-transitory readable storage medium, where the non-transitory readable storage medium stores a program or instructions, and when the program or the instructions are executed by a processor, the processes of the foregoing method embodiments in FIG. 2 to FIG. 5 are implemented, with the same technical effects achieved. To avoid repetition, details are not described herein again.

The processor is a processor in the terminal described in the foregoing embodiment. The non-transitory readable storage medium includes a non-transitory computer-readable storage medium such as a computer read-only memory ROM, a random access memory RAM, a magnetic disk, or an optical disc.

An embodiment of this application further provides a chip, where the chip includes a processor and a communication interface, the communication interface is coupled to the processor, and the processor is configured to run a program or instructions, so as to implement the processes of the method embodiments in FIG. 2 to FIG. 5, with the same technical effects achieved. To avoid repetition, details are not described herein again.

It should be understood that the chip mentioned in this embodiment of this application may also be referred to as a system-on-chip, a system chip, a system-on-a-chip, or a system on a chip, or the like.

An embodiment of this application further provides a computer program/program product, where the computer program/program product is stored in a non-transitory storage medium, and when being executed by at least one processor, the computer program/program product is configured to implement the processes of the foregoing method embodiments in FIG. 2 to FIG. 5, with the same technical effects achieved. To avoid repetition, details are not repeated herein.

An embodiment of this application further provides a model processing, execution, and registration system, which includes a first device, a second device, a first terminal, and a third device, where the first device can be configured to perform the steps of the model processing method shown in FIG. 2, the second device can be configured to perform the steps of the model processing method shown in FIG. 3, the first terminal can be configured to perform the steps of the model execution method shown in FIG. 4, and the third device can be configured to perform the steps of the model registration method shown in FIG. 5.

It should be noted that in this specification, the terms “include” and “comprise”, or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. In addition, it should be noted that the scope of the method and apparatus in the implementations of this application is not limited to functions being performed in the order shown or discussed, but may further include functions being performed at substantially the same time or in a reverse order, depending on the functions involved. For example, the described method may be performed in an order different from the order described, and steps may be added, omitted, or combined. In addition, features described with reference to some examples can be combined in other examples.

According to the description of the foregoing implementations, persons skilled in the art can clearly understand that the method in the foregoing embodiments may be implemented by a computer software product in combination with a necessary general hardware platform. The method in the foregoing embodiments may alternatively be implemented by hardware. The computer software product is stored in a storage medium (such as a ROM, a RAM, a magnetic disk, or an optical disc), and includes several instructions to enable a terminal or a network-side device to execute the methods described in the embodiments of this application.

The foregoing describes the embodiments of this application with reference to the accompanying drawings. However, this application is not limited to the foregoing embodiments. The foregoing embodiments are merely illustrative rather than restrictive. As instructed by this application, persons of ordinary skill in the art may develop many other implementation manners without departing from principles of this application and the protection scope of the claims, many and all such implementation manners fall within the protection scope of this application.

What is claimed is:

1. A model processing method, comprising:
sending, by a first device, a first message to at least one second device, wherein the first message comprises a first model file corresponding to a first model; and
receiving, by the first device, a second message returned by a second device; wherein
the second message comprises at least one of the following:
processing result information used for indicating a result obtained by processing the first model file; or
a second model file, wherein the second model file is obtained by converting the first model file.

2. The model processing method according to claim 1, wherein the method further comprises:
assigning, by the first device, a first identifier to the first model, wherein the first identifier is used to identify the first model.

3. The model processing method according to claim 2, wherein the first message further comprises the first identifier.

4. The model processing method according to claim 1, wherein the first message further comprises first information, and the first information comprises at least one of the following:
information for indicating a version number of the first model;
information for indicating at least one parameter corresponding to the first model;
information for indicating a use condition or a use scenario of the first model;
information for indicating at least one function supported by the first model;
information for indicating a generating device or a training device of the first model; or
information for indicating a using device of the first model.

5. The model processing method according to claim 1, wherein the method further comprises:
receiving, by the first device, a third message sent by a third device, wherein the third message comprises the first model file, and the third message is used for registering the first model.

6. The model processing method according to claim 5, wherein the method further comprises:
sending, by the first device, a fourth message to the third device; wherein
the fourth message comprises at least one of the following:
the processing result information; or
the second model file.

7. The model processing method according to claim 6, wherein the fourth message further comprises at least one of the following:
a first identifier for identifying the first model;
the first model file;
first information, wherein the first information comprises at least one of the following: information for indicating a version number of the first model; information for indicating at least one parameter corresponding to the first model; information for indicating a use condition or a use scenario of the first model; information for indicating at least one function supported by the first model; information for indicating a generating device or a training device of the first model; or information for indicating a using device of the first model; or
first indication information for indicating information about a manufacturer corresponding to the second device.

8. The model processing method according to claim 1, wherein the method further comprises:
sending, by the first device, a fifth message to a first terminal, wherein the fifth message comprises the first model file or the second model file.

9. The model processing method according to claim 8, wherein the fifth message further comprises at least one of the following:
a first identifier for identifying the first model; or
first information, wherein the first information comprises at least one of the following: information for indicating a version number of the first model; information for indicating at least one parameter corresponding to the first model; information for indicating a use condition or a use scenario of the first model; information for indicating at least one function supported by the first model; information for indicating a generating device or a training device of the first model; or information for indicating a using device of the first model.

10. The model processing method according to claim 8, wherein the sending, by the first device, a fifth message to a first terminal comprises at least one of the following:
sending, by the first device, the fifth message to the first terminal in a case that the first terminal has registered with the first device;
sending, by the first device, a sixth message to the first terminal in a case that a first request is received from the first terminal, wherein the first request is used to query whether there is an undownloaded or updated model file, and the sixth message is used for indicating that there is an undownloaded or updated model file in the first device; and sending, by the first device, the fifth message to the first terminal in a case that a second request is received from the first terminal, wherein the second request is used for obtaining the fifth message; or
sending, by the first device, the fifth message to the first terminal in a case that a seventh message is received from the first terminal, wherein the seventh message comprises at least one of the following: a first identifier for identifying the first model; information for indicating a version number of the first model; or second indication information for indicating information about a manufacturer or terminal model corresponding to the first terminal.

11. A model processing method, comprising:
receiving, by a second device, a first message sent by a first device, wherein the first message comprises a first model file corresponding to a first model; and
returning, by the second device, a second message to the first device; wherein
the second message comprises at least one of the following:
processing result information used for indicating a result obtained by processing the first model file; or
a second model file, wherein the second model file is obtained by converting the first model file.

12. The model processing method according to claim 11, wherein the first message further comprises a first identifier, and the first identifier is assigned to the first model by the first device and the first identifier is used for identifying the first model.

13. The model processing method according to claim 11, wherein the first message further comprises first information, and the first information comprises at least one of the following:
information for indicating a version number of the first model;
information for indicating at least one parameter corresponding to the first model;
information for indicating a use condition or a use scenario of the first model;
information for indicating at least one function supported by the first model;
information for indicating a generating device or a training device of the first model; or
information for indicating a using device of the first model.

14. The model processing method according to claim 11, wherein the method further comprises:
sending, by the second device, a fifth message to a first terminal, wherein the fifth message comprises the first model file or the second model file.

15. The model processing method according to claim 14, wherein the fifth message further comprises at least one of the following: a first identifier for identifying the first model; or first information, wherein the first information comprises at least one of the following: information for indicating a version number of the first model; information for indicating at least one parameter corresponding to the first model; information for indicating a use condition or a use scenario of the first model; information for indicating at least one function supported by the first model; information for indicating a generating device or a training device of the first model; or information for indicating a using device of the first model.

16. The model processing method according to claim 14, wherein the sending, by the second device, a fifth message to a first terminal comprises at least one of the following:
sending, by the second device, the fifth message to the first terminal in a case that the first terminal has registered with the second device;
sending, by the second device, an eighth message to the first terminal in a case that a third request is received from the first terminal, wherein the third request is used to query whether there is an undownloaded or updated model file, and the eighth message is used for indicating that there is an undownloaded or updated model file in the second device; and sending, by the second device, the fifth message to the first terminal in a case that a fourth request is received from the first terminal, wherein the fourth request is used for obtaining the fifth message; or
sending, by the second device, the fifth message to the first terminal in a case that a ninth message is received from the first terminal, wherein the ninth message comprises at least one of the following: a first identifier for identifying the first model; information for indicating a version number of the first model; or second indication information for indicating information about a manufacturer or terminal model corresponding to the first terminal.

17. A communication device, comprising a processor and a memory, wherein a program or instructions executable on the processor are stored in the memory, and the program or instructions, when executed by the processor, cause the communication device to perform:
sending a first message to at least one second device, wherein the first message comprises a first model file corresponding to a first model; and
receiving a second message returned by a second device; wherein
the second message comprises at least one of the following:
processing result information used for indicating a result obtained by processing the first model file; or
a second model file, wherein the second model file is obtained by converting the first model file.

18. The communication device according to claim 17, wherein the program or instructions, when executed by the processor, cause the communication device to further perform:
assigning a first identifier to the first model, wherein the first identifier is used to identify the first model.

19. The communication device according to claim 17, wherein the program or instructions, when executed by the processor, cause the communication device to further perform:
receiving a third message sent by a third device, wherein the third message comprises the first model file, and the third message is used for registering the first model.

20. A communication device, comprising a processor and a memory, wherein a program or instructions executable on the processor are stored in the memory, and when the program or instructions are executed by the processor, the steps of the model processing method according to claim 11 are implemented.
